(19) United States
(12) Patent Application Publication
(10) Pub. No.: US 2026/0166516 A1
(43) Pub. Date: Jun. 18, 2026

(54) SYSTEM FOR BATCH-SCALE PRODUCTION OF EUTECTIC SOLVENT-BASED SORBENT MATERIALS USING 3D PRINTING

(71) Applicant: Iowa State University Research Foundation, Inc., Ames, IA (US)

(72) Inventors: Jared L. Anderson, Ames, IA (US); Danial Shamsaei, Ames, IA (US); Shu-An Hsieh, Ames, IA (US); Emma Lourdes Katubig, Ames, IA (US); Saxon J. Ryan, Ames, IA (US)

(21) Appl. No.: 19/368,907

(22) Filed: Oct. 24, 2025

Related U.S. Application Data
(60) Provisional application No. 63/711,479, filed on Oct. 24, 2024.

(51) Int. Cl. B01J 20/22; B01J 20/28; B01J 20/281; B01J 20/30; B33Y 10/00; B33Y 30/00; B33Y 40/10; B33Y 40/20; B33Y 80/00

(52) U.S. Cl. CPC B01J 20/22; B01J 20/28023; B01J 20/281; B01J 20/3007; B33Y 10/00; B33Y 30/00; B33Y 40/10; B33Y 40/20; B33Y 80/00; B01J 2220/44; B01J 2220/54

(57) ABSTRACT

This disclosure relates to systems and methods for 3D printed eutectic extraction sorbents. The application discloses the use of both SLA and LCD printers as well as modifications to those printers to make them suitable for inclusion in the systems and methods disclosed herein. Also described are methods of manufacturing eutectic extraction sorbents and methods of analyte extraction using the eutectic extraction sorbents.

### CROSS-REFERENCE

This application claims priority under 35 U.S.C. § 119 to provisional application Ser. No. 63/711,479, filed Oct. 24, 2024, which is incorporated by reference in its entirety.

### STATEMENT REGARDING FEDERALLY SPONSORED RESEARCH OR DEVELOPMENT

This invention was made with government support under Grant Number CH-E2203891, awarded by the National Science Foundation and under Contract Number DE-AC02-07CH11358, awarded by the U.S. Department of Energy. The government has certain rights in the invention.

### TECHNICAL FIELD

The present disclosure relates generally to a system and method for 3D printed eutectic extraction sorbents.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Three-dimensional (3D) printing has grown significantly in various interdisciplinary fields, such as analytical chemistry, by offering rapid prototyping, easy design customization, user-friendly operation, and cost-effectiveness. However, commercial 3D printers require large volumes of printing materials, posing a challenge for the development of new printable materials. Additionally, failed or undesirable polymerization of the prepolymer mixture can lead to substantial waste due to the large volume requirements, often reaching hundreds of milliliters. Therefore, developing simple and low-cost modifications to commercial 3D printers that reduce the required volume of prepolymer materials to just a few milliliters remains an unmet need. This would significantly accelerate the production of new 3D-printed materials, particularly for separation purposes and sample preparation.

Stereolithography (SLA) is one of the most used 3D printing techniques in the additive manufacturing industry. SLA printers use a UV light source to polymerize prepolymer mixture in a layer-by-layer process within a resin tank. SLA-printed objects are highly detailed and have smooth surfaces due to the high precise and small contact area of the light source. The process operates on the principle of photopolymerization and typically involves a vat of photopolymerizable resin, a movable platform, and a light source. Alternatively, LCD 3D printing involves the use of LCD screens to mask light from an LED source and selectively cure the desired cross-section of the part. Recent developments have demonstrated the potential of using 3D printed materials as extraction sorbents. Customizing these materials for the extraction of specific target analytes can further reduce costs and tailor applications precisely.

Sample preparation is an important step in chemical analysis, particularly in detecting analytes at trace levels, since minimizing or eliminating matrix interferences can increase sensitivity. Numerous miniaturized extraction techniques, including, but not limited to dispersive liquid-liquid extraction (DLLME), solid-phase microextraction (SPME), stir bar sorptive microextraction (SBSE), thin-film microextraction (TFME), vortex-assisted solid-phase microextraction (VA-DSPME), capsule-phase microextraction (CPME), and dispersive solid phase extraction (d-SPE), have been developed to preconcentrate target analytes from complex samples. Among these, SPME is often employed for extracting volatile, semi-volatile, and non-volatile analytes from sample matrixes and has been widely applied in environmental monitoring, as well as in food and pharmaceutical analysis. The technique consists of a fiber support coated with a sorbent material that is exposed to the sample. After extraction, a thermal or solvent desorption process is performed by exposing the fiber to elevated temperatures or an organic solvent, respectively. Compared to other extraction techniques, SPME offers several advantages, including simplicity, low analyte detection limits, and versatility in the type of sorbent coating materials that can be tailored toward specific classes of analytes.

Three-dimensional (3D) printing, also known as additive manufacturing, has grown significantly in a number of fields due to its advantages of rapid prototyping, while also being cost-effective, and easy to use. The costs of 3D printers have become more affordable in recent years, allowing them to expand to a number of areas within scientific and industrial research, such as dentistry, architecture building, food science, drug delivery, and analytical chemistry. However, developing novel printable materials has been hindered by the requirement of large volumes of prepolymer materials for commercial 3D printers, resulting in high costs. Furthermore, unsuccessful or undesirable polymerization of the tested prepolymer mixture can lead to significant waste due to the large volume requirements, which are often in the hundreds of milliliters. This underscores the need to develop simple and low-cost platform modifications for use in commercial 3D printers to accelerate the production of 3D printed materials, particularly for separation media used in chemical separations and sample preparation.

Thus, there exists a need in the art for a system that introduces modifications to a commercial SLA 3D printing system that enables the production of 3D-printed extraction sorbents, such as blades and fibers. Further, there is a need for new printed sorbent materials that can be used for extraction and which reduce the amount of prepolymer material required and offer a low-cost, eco-friendly, simple, repeatable, and efficient method for the batch production of extraction sorbents.

### SUMMARY

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

A preferred embodiment is a system for 3D printing eutectic extraction sorbents comprising a photocuring 3D printer utilizing a build plate having a plurality of holes and a resin tank formed of a plurality of individual wells with a mixture of a hydrogen bond donor, a hydrogen bond acceptor, and a photoinitiator, the mixture placed in the plurality of wells to form a plurality of 3D printed eutectic extraction sorbents on the build plate; a fabrication device that prepares the 3D printed eutectic extraction sorbents for extraction; at least one container for conditioning, extracting, and desorption of the 3D printed eutectic extraction sorbents.

A preferred embodiment is a eutectic extraction sorbent comprised of a eutectic material comprised of a hydrogen bond donor and a hydrogen bond acceptor; wherein the eutectic extraction sorbent is in the form of a blade or a fiber; wherein the hydrogen bond donor comprises N-(hydroxymethyl) acrylamide, N-isopropylacrylamide, N-vinylcaprolactam, maleic acid, acrylic acid, methacrylic acid, acrylamide, itaconic acid, 4-acryloylmorpholine, malonic acid, N,N′-methylenebis(acrylamide), hydroxyethyl methacrylate, citric acid, amidoxime, tannic acid, oxalic acid, benzeneimidamide, trifluorobenzeneimidamide, propanimidamide, diaminopyridine, piperazinediamine, diaminopropane, ethylene glycol, triethylene glycol, succinic acid, sulfonic acid, levulinic acid, formic acid, phosphoric acid, 1,4-butanediol, and 2,3-butanediol, or a combination or mixture of the foregoing; and wherein the hydrogen bond acceptor comprises choline chloride, vinyl acetate, urea, ethylammonium chloride, acetylcholine chloride, tetrabutylphosphonium chloride, tetrabutylammonium chloride, cholinium bromide methacrylate, diallyldimethylammonium chloride (DMDAAC), and methyl methacrylate, alanine, betaine, glycine, guanidine hydrochloride, tetramethyl ammonium chloride, tetraethyl ammonium chloride, tetrapropyl ammonium chloride, methyl triethyl ammonium chloride, butyl trimethyl ammonium chloride, chlorocholine chloride, allyl trimethyl ammonium chloride, benzyl trimethyl ammonium chloride, benzyl triethyl ammonium chloride, or a mixture thereof.

A preferred embodiment is a method of manufacturing eutectic extraction sorbents comprising: placing a hydrogen bond donor and a hydrogen bond acceptor with a photoinitiator into a customized resin tank formed of a plurality of individual wells; utilizing a photocuring 3D printer having a build plate with a plurality of holes and the customized resin tank formed of a plurality of individual wells; and printing the eutectic extraction sorbent.

A preferred embodiment is a method of analyte extraction comprising: contacting a eutectic extraction sorbent described herein with a sample, wherein the sample comprises an analyte; and wherein the analyte is a solid and is adsorbed, or a liquid and is absorbed.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE FIGURES

The following drawings form part of the specification and are included to further demonstrate certain embodiments. In some instances, embodiments can be best understood by referring to the accompanying figures in combination with the detailed description presented herein. The description and accompanying figures may highlight a certain specific example, or a certain embodiment. However, one skilled in the art will understand that portions of the example or embodiment may be used in combination with other examples or embodiments. Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a side schematic view of a 3D (additive) printing operation associated with the disclosed invention.

FIG. 2 is a bottom view of a commercial resin tank and a bottom view of a commercial build plate for a standard LCD 3D printer.

FIG. 3 is a bottom view of a customized six-hole build plate for a standard LCD 3D printer.

FIG. 4 is a top view of a customized six-hole build plate for a standard LCD 3D printer shown in FIG. 3.

FIG. 5 is a bottom view of a customized six-well resin tank for a standard LCD 3D printer.

FIG. 6 is a bottom view of a customized twenty-four-hole build plate for a standard LCD 3D printer.

FIG. 7 is a top view of a customized twenty-four hole build plate for a standard LCD 3D printer shown in FIG. 6.

FIG. 8 is a bottom view of a customized twenty-four well resin tank for a standard LCD 3D.

FIG. 9 is a schematic of the setup for a 6-hole build plate and a 24-hole build plate when printing with an FDM 3D printer.

FIG. 10 is a schematic of a model file to set up parameters for printing with a FDM 3D printer using black polylactic acid filament.

FIG. 11 is a side view of an assembly of one of the twenty-four-hole build plates that includes one screw, two hex nuts, and five round disc magnets.

FIG. 12 is a side view of an assembly of the six-hole build plate using two screws and a flat head nut.

FIG. 13A is a schematic of modifications made to a commercial 3D printer (left) resulting in a modified 3D printer (right) involving the additions of a build plate holder, six screws used as miniaturized build plates, and a 6-well cell plate serving as the resin tank.

FIG. 13B is a side view of the modified 3D printer.

FIG. 13C is a top-down view of the modified 3D printer.

FIG. 13D is a schematic of the screws used as miniaturized build plates.

FIGS. 14A-B is a 3D schematic of the digital model for 3D printing fibers.

FIGS. 14C-D is a 3D schematic of the digital model for 3D printing blades.

FIG. 15A is a side view of 3D printed PDES-fibers using (ChCl:Aam:AcMo) with a molar ratio of 1:4:1.

FIG. 15B is a side view of 3D printed PDES-fibers using (ChCl:Aam:AcMo) with a molar ratio of 1:4:2.

FIG. 15C is a side view of 3D printed PDES-fibers using (ChCl:Aam:AcMo) with a molar ratio of 1:6:3.

FIG. 15D is a side view of 3D printed PDES-fibers using (ChCL:AcrylicAcid) with a molar ratio 1:2.4

FIG. 15E is a side view of 3D printed PDES-fibers using (ChCL:AcrylicAcid) with a molar ratio 1:4.6.

FIG. 16A is a graph showing comparisons of the masses of PDES fibers using (ChCl:AAm:AcMo) with molar ratios 1:4:1, 1:4:2, and 1:6:3 before and after UV curing.

FIG. 16B is a graph showing comparisons of the masses of PDES blades using (ChCl:AAm:AcMo) with molar ratios 1:4:1, 1:4:2, and 1:6:3 before and after UV curing.

FIG. 17A is a schematic of modifications made to a commercial 3D printer (left) resulting in a modified 3D printer (right) involving the additions of a redesigned build plate, an altered resin tank, and deactivated sensors.

FIG. 17B is a side view of the modified build plate.

FIG. 17C is a side view of the modified resin tank.

FIG. 17D is a schematic illustrating the locations of the sensors and the method used to deactivate the sensors.

FIG. 18 is an expanded view of the customized build plate designed for use within the modified FormLabs 3D printer.

FIGS. 19A-C is a set of side views and top view in PreForm software.

FIG. 19D is a side view of a fiber model with a diameter of 0.5 mm and a length of 15 mm in Inventor software.

FIG. 20A is a modified SLA 3D printer for printing PDES sorbents.

FIG. 20B is a modified sorbent pen with mesh, 3D printed sorbent, and cork piece.

FIG. 20C is a connection of modified pens to 40 ml vials under vacuum.

FIG. 20D is extraction using the SPES system.

FIG. 20E is thermal desorption and GC-MS analysis with the SPDU unit.

FIG. 21A is a 3D printed PDES using (TBA)Cl:AAm:AcMo with the molar ratio 1:6:3.

FIG. 21B is a 3D printed PDES using (TBA)Cl:NMA:AcMo with the molar ratio 1:6:3.

FIG. 21C is a 3D printed PDES using (TBP)Cl:NIPAM:NVCL with the molar ratio 1:6:3.

FIG. 22A shows 3D printed PDES fibers from Anycubic printer (left) and FormLabs printer (right) for prepolymer mixture of ChCl:AAm:AcMo with the molar ratio of 1:6:3.

FIG. 22B shows 3D printed PDES fibers from Anycubic printer (left) and FormLabs printer (right) for prepolymer mixture of (TBA)Cl:AAm:AcMo with the molar ratio 1:6:3.

FIG. 22C shows 3D printed PDES fibers from Anycubic printer (left) and FormLabs printer (right) for prepolymer mixture of (TBA)Cl:NMA:AcMo with the molar ratio 1:6:3.

FIG. 22D shows 3D printed PDES fibers from Anycubic printer (left) and FormLabs printer (right) for the prepolymer mixture (TBP)Cl:NIPAM:NVCL with the molar ratio 1:6:3.

FIG. 23A is a set of printed prepolymer mixtures.

FIG. 23B is a set of unsuccessful prepolymer mixtures.

FIG. 23C is a set of preliminary tested prepolymer mixtures.

FIG. 24 is a graph showing thermogravimetric analysis of 3D printed ChCl:AAm:AcMo and (TBA)Cl:AAm:AcMo PDES sorbents.

FIG. 25 shows GC-MS chromatograms obtained from extractions using 3D printed PDES fibers performed with three formulations and the analytes β-pinene, terpinene, linalool, isoborneol, menthol, geraniol, eugenol, and nerolidol.

FIG. 26 is a table of the printed DES samples.

FIG. 27 is a table of the preliminary tested combinations of DES samples.

FIG. 28 is a table of unsuccessful combinations of DES samples.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit the basic operation of the present disclosure unless otherwise indicated.

So that the present disclosure may be more readily understood, certain terms are first defined. Unless defined otherwise, all technical and scientific terms used herein have the same meaning as commonly understood by one of ordinary skill in the art to which embodiments of the disclosed and methods pertain.

### Definitions

It is to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicate otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various embodiments of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

The term “about,” as used herein, refers to variations in size, distance, concentration, temperature, wavelength, pKa, or any other types of measurements that can be resulted from the inherent heterogeneous nature of the measured objects and imprecise nature of the measurements themselves. The term “about” also encompasses variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods, and the like. The term “about” also encompasses amounts that differ due to different equilibrium conditions for a composition resulting from a particular initial mixture. Whether or not modified by the term “about”, the claims include equivalents to the quantities.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Alkenyl groups or alkenes are straight chain, branched, or cyclic alkyl groups having 2 to about 30 carbon atoms, and further including at least one double bond. In some embodiments, alkenyl groups have from 2 to about 20 carbon, or typically, from 2 to 10 carbon atoms. Alkenyl groups may be substituted or unsubstituted. Alkenyl groups may be substituted similarly to alkyl groups.

As used herein, the terms “alkylene”, “cycloalkylene”, “alkynylene”, and “alkenylene”, alone or as part of another substituent, refer to a divalent radical derived from an alkyl, cycloalkyl, or alkenyl group, respectively, as exemplified by —CH₂CH₂CH₂—. For alkylene, cycloalkylene, alkynylene, and alkenylene groups, no orientation of the linking group is implied.

As used herein, “aryl” or “aromatic” groups are cyclic aromatic hydrocarbons that do not contain heteroatoms. Aryl groups include monocyclic, bicyclic, and polycyclic ring systems. Thus, aryl groups include, but are not limited to, phenyl, azulenyl, heptalenyl, biphenylenyl, indacenyl, florenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, in others from 6 to 12 or 6-10 carbon atoms in the ring portions of the groups. The phrase “aryl groups” includes groups containing fused rings, such as fused aromatic-aliphatic ring systems. Aryl groups may be substituted or unsubstituted.

As used herein, the term “exemplary” refers to an example, an instance, or an illustration, and does not indicate a most preferred embodiment unless otherwise stated.

The term “substantially” refers to a great or significant extent. “Substantially” can thus refer to a plurality, majority, and/or a supermajority of said quantifiable variables, given proper context.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims.

As used herein, the term “eutectic” refers to a mixture of chemical compounds or elements that has a single melting point that is lower than the melting points of its individual components. The term includes alloys of inorganics (mostly hydrated salts) and/or organics and encompasses all possible eutectics including but not limited to “deep eutectics”.

The term “photoinitiator” encompasses all possible photoinitiator relevant to 3D printing, including but not limited to Type I photoinitiators which decompose upon exposure to light, generating free radicals directly and Type II photoinitiators which require a co-initiator or sensitizer to produce free radicals upon light exposure, typically through a hydrogen transfer reaction.

### Printing Eutectic Sorbents

Eutectic materials, including deep eutectics, have many promising features for liquid-liquid extraction and solid-phase extraction techniques due to their unique properties. Eutectics offer tunable viscosity, density, hydrophobicity, and hydrophilicity, which can be adjusted by selecting appropriate hydrogen bond donors (HBD) and hydrogen bond acceptors (HBA). Compared to ionic liquids (ILs), Eutectics are more cost-effective, versatile, and less toxic. Eutectics are formed through the establishment of hydrogen bonds between HBA and HBD, resulting in a eutectic mixture with a lower melting point than that of the individual components. Polymerized deep eutectic solvents (PDES) formed by HBA and a polymerizable monomer that acts as both an HBD and a vinyl monomer, have tunable selectivity, negligible vapor pressure, and thermal stability, which are advantageous for developing new fibers used in solid-phase microextraction (SPME). Accordingly, this disclosure provides systems and methods of manufacturing eutectic sorbents, eutectic sorbent materials, and methods of using eutectic sorbents.

A feature of this disclosure is a modification to a commercial resin 3D printer that significantly reduces the amount of prepolymer material needed for the production of polymerized eutectics formed by a hydrogen bond acceptor (HBA) and a polymerizable monomer that acts as both as a hydrogen bond donor (HBD) and a vinyl monomer. As disclosed herein, a printing system can be provided that prints at low and very low volumes and manufactures blades, fibers, or other sorbents with appropriate dimensions for TFME, SPME and other extraction techniques. Although other geometries are feasible, two geometries resembling a blade-type extraction sorbent used in thin-film microextraction (TFME), and a fiber-type extraction sorbent used in solid-phase microextraction (SPME) were examined.

Beneficially this disclosure also provides simple, low-cost modifications to a commercial desktop light crystal display (LCD) 3D printers and SLA 3D printers that enables the printing of eutectic materials using prepolymer mixture volumes ranging from a hundred microliters to tens of milliliters. Prepolymer mixtures consisting of a HBA and a polymerizable monomer that acts as both a HBD and a vinyl monomer were blended with a photoiniator to fabricate eutectic sorbents.

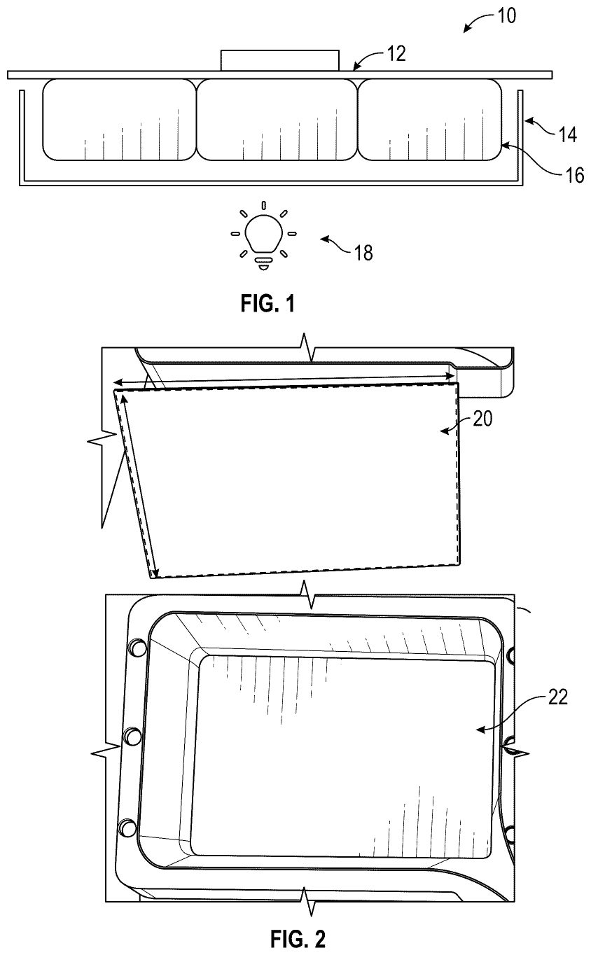

A central component of this system is a 3D or additive manufacturing printer that provides a method of creating three-dimensional objects layer-by-layer utilizing computer modeling design. Preferably, this includes a liquid crystal diode 3D printer. Referring now to FIG. 1, the main components of a 3D printer are generally indicated by the numeral 10. This includes a build plate 12 and a material tank 14 that holds the 3D printing material 16, such as prepolymers, e.g., a mixture of monomer, crosslinker, photoinitiator, and so forth. There is also a light source 18, e.g., liquid crystal diode. Illustrative, but nonlimiting examples, of 3D printers that can be utilized include SLA, SLA-LCD, and SLA-DLP type printers. Black polylactic acid (PLA) filament (2.85 millimeter diameter) was obtained from Dynamism Inc. in Chicago, Illinois; the black PLA was printed on an FDM printer to form the custom build plate used for the methods disclosed herein.

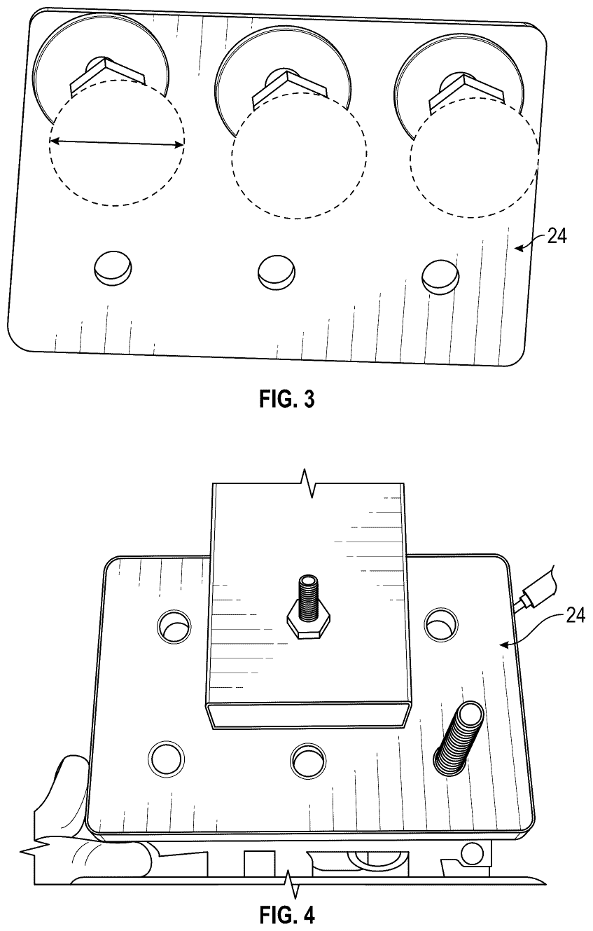

For comparison, FIG. 2 shows the commercial build plate 20 and a commercial material tank 22. The commercial build plate 20 features rectangular dimensions of 85 millimeters (length)×125 millimeters (width).

Miniaturization of the LCD 3D printer 10 includes modification to the build plate 12 and material, e.g., resin, tank 14. A six-hole customized build plate is indicated by the numeral 24 in FIG. 3. The top view of the six-hole customized build plate 24 is shown in FIG. 4. The six-hole build plate 24 has six circular holes having diameters of preferably, but not necessarily, 8.5 millimeters.

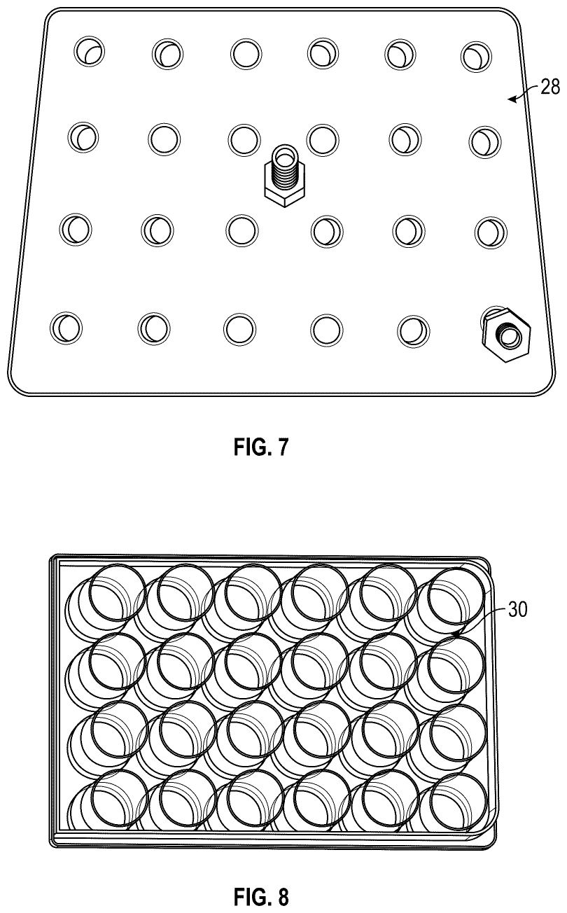

A twenty-four-hole customized build plate is indicated by the numeral 28 in FIG. 6. The top view of the six-hole customized build plate 28 is shown in FIG. 7. The twenty-four hole build plate 28 has twenty-four printing platforms with a circular shape and a diameter of preferably, but not necessarily, five millimeters.

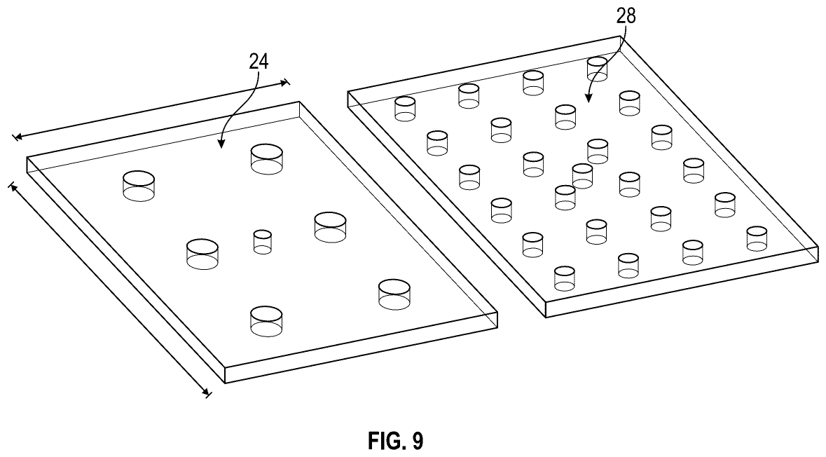

The software first modeled six-hole and twenty-four-hole customized build plates 24 and 28, respectively, shown in FIG. 9, to preferably have dimensions of 125 millimeters×85 millimeters×5 millimeters (L×W×H).

An illustrative, but nonlimiting example of this type of software includes Autodesk Inventor® software. Autodesk Inventor® is a federally registered trademark of Autodesk, Inc., having a place of business at The Landmark @ One Market 1 Market Street, Suite 400, San Francisco, California 94105.

Both computer-aided design software files were transferred to a slicer to set up printing parameters and then to a printer. Nonlimiting, but illustrative examples include an Ultimaker® Cura slicer and an Ultimaker® S5 3D printer. Ultimaker® is a federally registered trademark of Ultimaker Holding BV, having a place of business at Watermolenweg 2, Geldermalsen, Netherlands 4191PL.

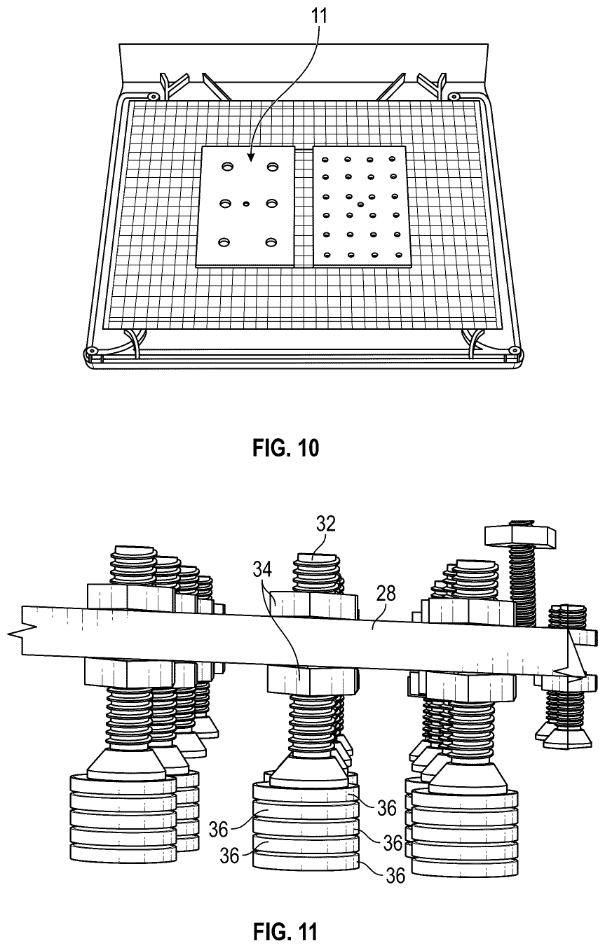

Printing occurs with black polylactic acid filament, as shown in FIG. 10 by numeral 11. The printing parameters are: a print speed of 100 millimeters/second; layer height of 0.15 millimeters; printing nozzle temperature of 200° C.; build plate 24, 28 temperature of 90° C.; and the nozzle type is an AA 0.4 nozzle.

Comparison of the three types of build plates 20, 24, and 28 are shown below in Table 1.

TABLE 1

| | Commercial 20 | 2 × 3 Build Plate 24 | 4 × 6 Build Plate 28 |
|---|---|---|---|
| Number of materials | Only one | Up to six | Up to twenty-four |
| can be printed | | | |
| simultaneously | | | |
| Minimal material | about 10-100 mL | about 1-3 mL | about 0.5-1 mL |
| volume required | | | |
| Usage | Larger print | Slightly larger print | For material testing |

After printing was complete, the screws and nuts are utilized to secure build plates to the LCD 3D printer 10. For example, referring now to FIG. 11, assembly of one of the twenty-four-hole build plates 28 can include, but not necessarily include, one 5/16″-18 screw 32, two hex nuts 34, and five round disc magnets 36.

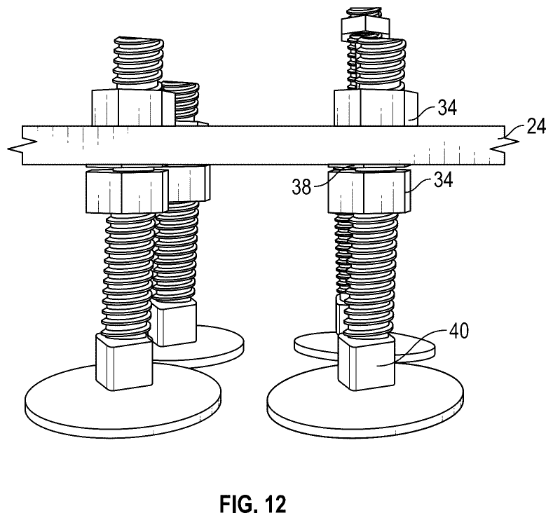

Referring now to FIG. 12, assembly of one of the six-hole build plates 24 can include, but not necessarily, one flat head screw 40, two hex nuts 34, and a locking washer 38.

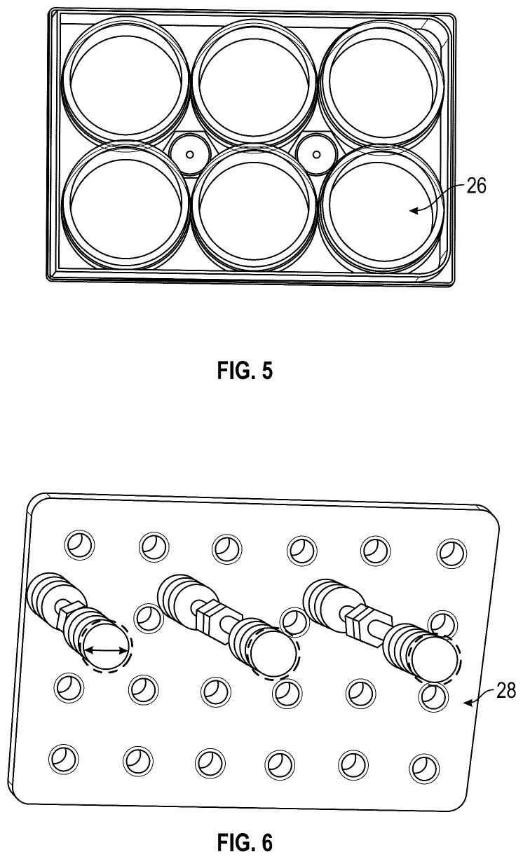

There is a twenty-four-well customized cell plate 30, which is shown in FIG. 8, and the six-well cell plate 26, which is shown in FIG. 5, that functions as miniaturized resin tanks and is preferably, but not necessarily, coated with PDMS. Polydimethylsiloxane (PDMS) is an elastomer with excellent optical, electrical, and mechanical properties. To coat a cell plate 30, 26, the Corning® cell culture plates were first cleaned thoroughly with a disposable wiping cloth made of soft, non-abrasive fibers that are designed to be gentle on delicate surfaces, e.g., Kimwipes®, using water and methanol to prevent dust from remaining on the plate. Corning® is a registered trademark of Corning Incorporated, having a place of business at One Riverfront Plaza, Corning, New York, and Kimwipes® is a federally registered trademark of the Kimberly-Clark Corporation, having a place of business at 401 North Lake Street, Neenah, Wisconsin 54956.

The PDMS elastomer was then poured into a small beaker at a volume ratio of ten milliliters to one milliliter of the curing reagent, followed by thorough manual mixing. The mixture was carefully poured into the wells until a thickness of approximately one millimeter was applied. The coated cell plates or resin tanks 30, 26 were left for twenty-four hours at room temperature before use.

The demand for large material volumes required for printing with commercial 3D printers presents a significant obstacle for researchers seeking to develop novel printable materials. By downsizing the volume of required starting materials, the prepolymer mixture can be more efficiently adapted for test printing while also significantly reducing costs and waste. To investigate the printability of PDES sorbents, a low-cost modification to a miniaturized commercial LCD printer was first performed. Two build-plate platforms with dimensions of 125 millimeters (height) and 85 millimeters (width) were modeled with software, e.g., Autodesk Inventor® software, as shown in FIG. 9. A 6-hole design 24 and 24-hole design 28 on the build plate platforms were matched to the distribution of wells within commercial cell culture plates. FIG. 10 shows the build plate base 10 (three-millimeter thickness) fabricated by a 3D printer, e.g., fused deposition modeling (FDM) 3D printer, using polylactic acid (PLA), e.g., black PLA filament. A total of six and twenty four screws and nuts were then assembled at each position of the holes on the build plate platform base, as shown in FIGS. 11 and 12. Five round disk magnets 36 with a circular diameter of twelve millimeters were applied to the screws 32 to form a flat surface on the build plate 28 for the twenty-four hole design.

Culture plates containing wells 30 were chosen to serve as miniaturized resin tanks because they are transparent and have a flat bottom, which permits ultraviolet (UV) light transmission. This configuration required only 800 to 1000 microliters of resin in each well to initiate a successful print, compared to commercial printing platforms that require more than 150 milliliters of resin to cover the entire resin tank. As provided in Table 1, minimal resin material is required in the methods disclosed herein.

To showcase the customizability of the modification method, a six-hole printing platform featuring six screws with a dimension of 30 millimeters was designed as a build plate 24 to print larger objects and compared to the 24-hole design 28, as shown in FIG. 11. Culture plates containing six wells were chosen to serve as the resin tank for this design, and a minimum volume of two, three, or four millimeters was required to initiate a print for this platform. Modifications that enable the use of different build plate sizes and material tank volumes demonstrate the versatility of this approach in customizing the desired printing requirements.

This modification was demonstrated in the simultaneous printing of ten blade-type PIL sorbents used in TFME, and twelve fiber-type sorbents used in SPME as examples of preferred extraction techniques. The SPME sorbents were used to extract a variety of emerging and persistent contaminants from water under optimal conditions, followed by chromatographic analysis. Analyte extraction efficiencies obtained from printed SPME sorbents were compared to those printed from the same batch as well as to those printed in different batches. The lifetimes of the printed sorbents provide a significant advantage.

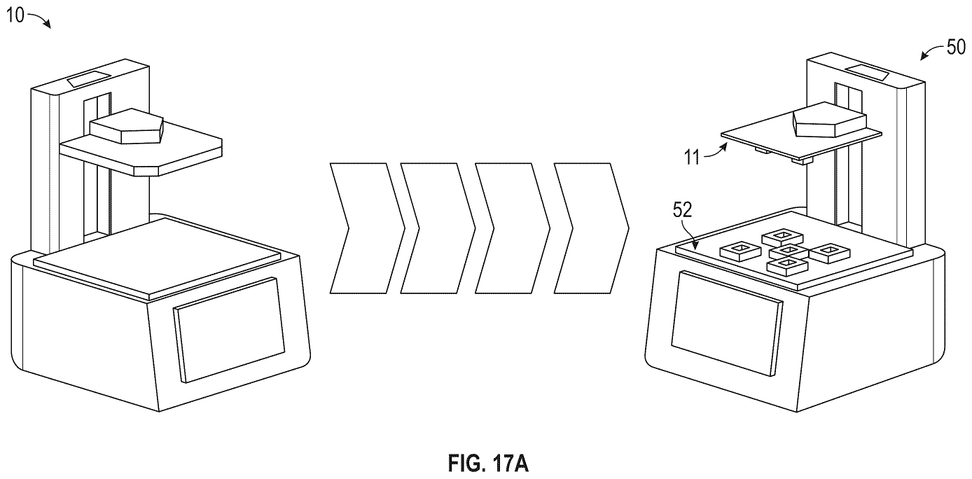

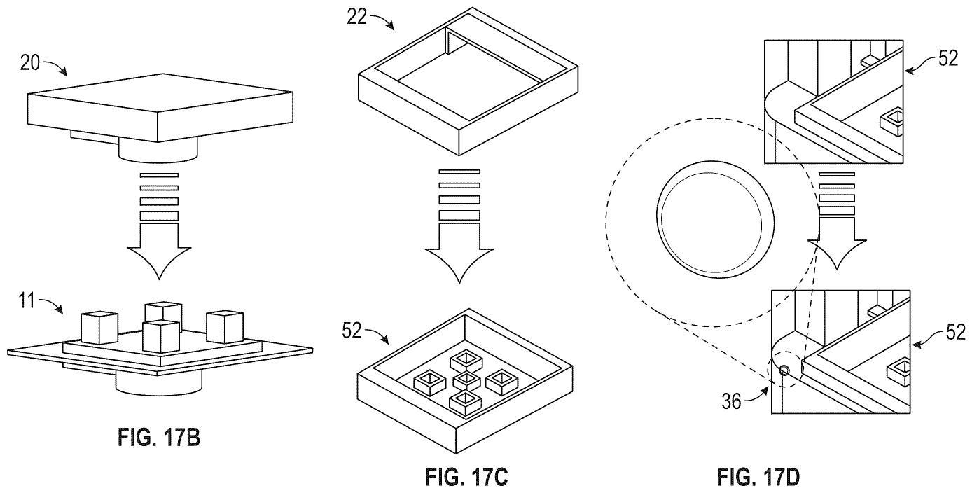

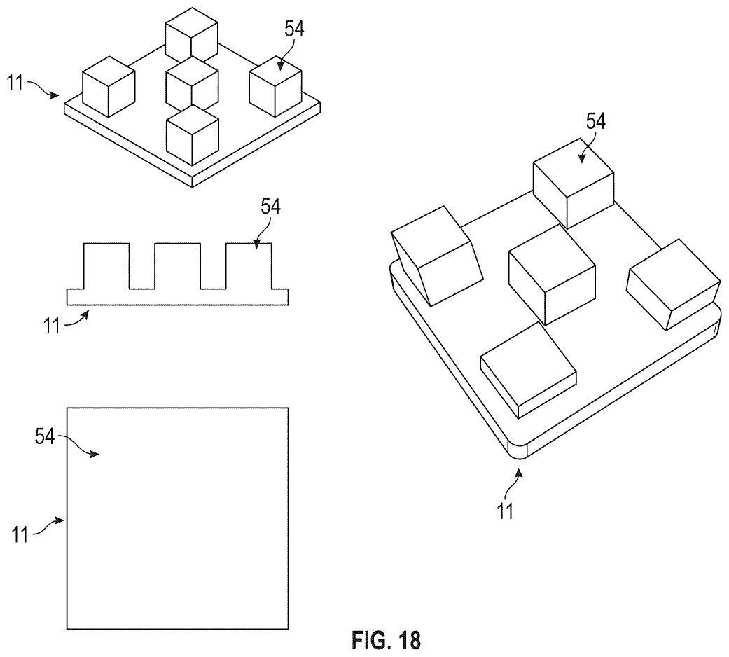

Modification of the SLA 3D printer involved customizing the build plate, resin tank, and sensors as shown in FIG. 17. Customized build plates are shown in FIG. 17C and FIG. 18, consisting of a base on which raised platforms are located. In a preferred embodiment, the customized build plate is fabricated from aluminum. In a preferred embodiment, the fabrication process involves computer numerical control (CNC) machining. The customized resin tank for the SLA 3D printer is shown in FIG. 17D. In a preferred embodiment, the customized resin tank consists of a square frame surrounding a square opening.

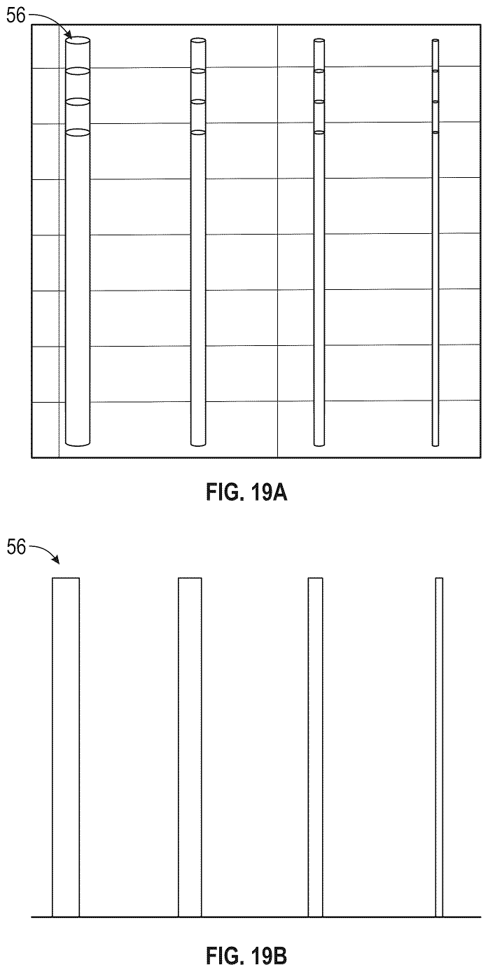

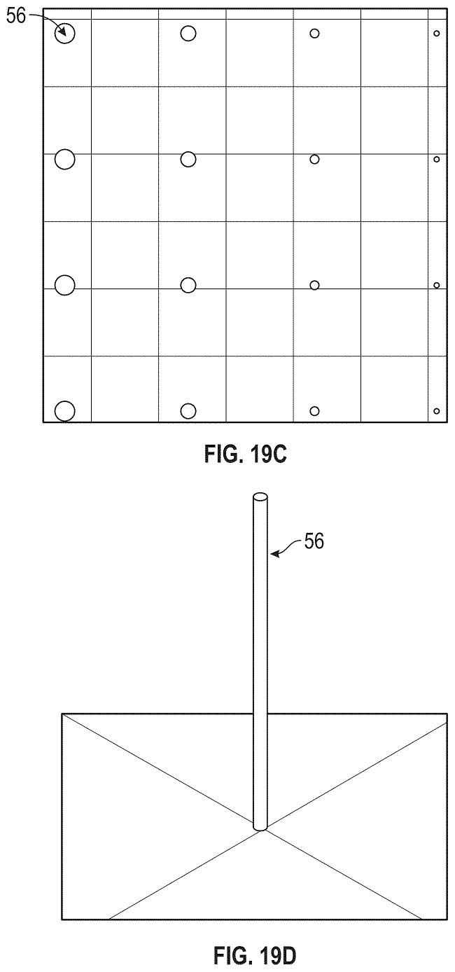

PDES sorbents for the SLA 3D printer can be printed in the form of fibers. Examples include fibers 0.3, 0.5, 0.7, and 0.9 mm in diameter and 12 mm in length, modeled in Inventor software. Designs can be exported into PreForm software are shown in FIG. 19. In a preferred embodiment, the resin is heated. In a preferred embodiment, the resin is heating by ramping the temperature from a starting temperature to an operating temperature. In a preferred embodiment, wiping within the SLA 3D printer is disabled. In a preferred embodiment, fibers printed using the SLA 3D printer are washed using a solvent. In a preferred embodiment, fibers printed using the SLA 3D printer undergo post-curing using UV light.

It is a further object, feature, and/or advantage of the present disclosure is a system for 3D printed extraction of eutectic sorbents that includes a photocuring 3D printer utilizing a build plate having a plurality of holes and a resin tank formed of a plurality of individual wells with a mixture of an HBD, an HBA, and a photoinitiator, the mixture placed in the plurality of wells to form a plurality of 3D printed eutectic extraction sorbents on the build plate, fabrication device that prepares the 3D printed eutectic extraction sorbents for extraction, at least one container for conditioning, extracting, and desorption of the 3D printed eutectic extraction sorbents, and a gas chromatography (GC) to provide separation resulting in a batch production of eutectic sorbents.

As depicted in the figures, a system for printing eutectic sorbents preferably comprises a build plate having a plurality of holes and the resin tank formed of a plurality of individual wells (which can optionally be created by a 3D printer). Preferably the plurality of individual wells of the resin tank are each coated with an elastomer.

Accordingly, a preferred method of manufacturing eutectic extraction sorbents comprises placing a hydrogen bond donor and a hydrogen bond acceptor with a photoinitiator into a customized resin tank formed of a plurality of individual wells; utilizing a photocuring 3D printer having a build plate with a plurality of holes and the customized resin tank formed of a plurality of individual wells; and printing the eutectic extraction sorbent. The sorbent can be printed in any form; preferred forms include as a blade or a cylindrical fiber. In a preferred embodiment, a plurality of sorbents are printed. In a preferred embodiment, the plurality of sorbents comprises both sorbents in the form of a blade and sorbents in the form of a fiber.

In a preferred embodiment, the method of manufacturing eutectic extraction sorbents further comprises the step of removing any uncured residual resin after the printing. In a preferred embodiment, the method of manufacturing further comprises the step of post-curing by applying UV light to the eutectic extraction sorbents after removing any uncured residual resin; and optionally the step of washing with a solvent. The solvent can be any suitable solvent that will not dissolve the sorbent. In a preferred embodiment the washing solvent comprises water and/or water miscible solvents.

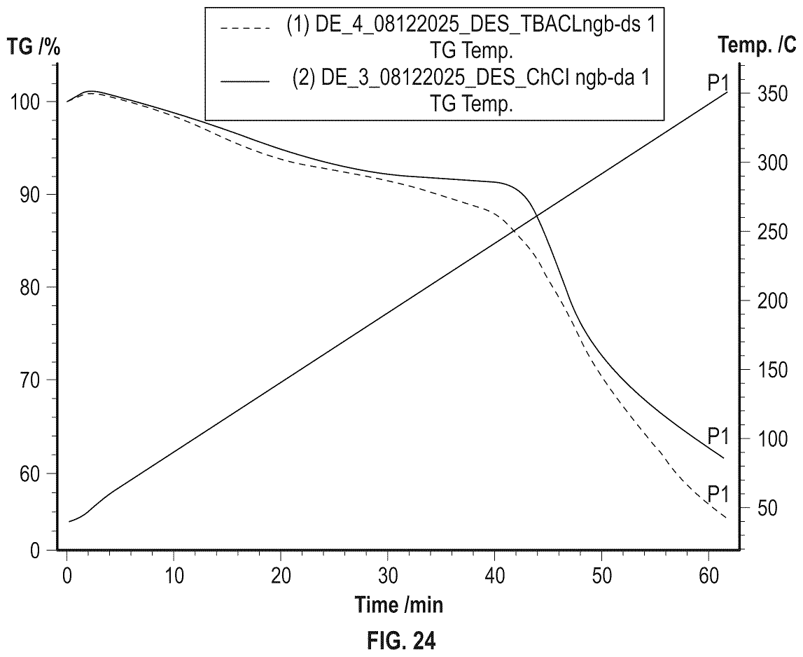

The thermal properties of 3D printed PDES sorbents can be tested. In a preferred embodiment, thermal properties of 3D printed PDES sorbents are tested using thermogravimentric analysis (TGA). Representative TGA results are shown in FIG. 24.

Prior to use in an extraction technique, a further step of conditioning the eutectic sorbent is preferably conducted.

As disclosed herein, the methods and systems for printing a eutectic sorbent include a prepolymer mixture comprising at least one HBA, at least one polymerizable monomer that acts as both a HBD and a vinyl monomer, and a photoinitiator. In a preferred embodiment, the ratio of HBA to HBD is from about 1:1 to about 1:8; more preferably 1:2 to about 1:6; the foregoing ranges are inclusive of all integers and decimals within the ranges (e.g., 1:2.4 and 1:5.8).

### Hydrogen Bond Donor (HBD)

Preferred HBDs include, but are not limited to, any carboxylic acid and any diol with the potential to perform polymerization. More preferred HBDs include, but are not limited to, N-(hydroxymethyl) acrylamide, N-isopropylacrylamide, N-vinylcaprolactam (NVCL), maleic acid, acrylic acid, methacrylic acid, acrylamide, itaconic acid, 4-acryloylmorpholine, malonic acid, N,N′-methylenebis(acrylamide), hydroxyethyl methacrylate, citric acid, amidoxime, tannic acid, oxalic acid, benzeneimidamide, trifluorobenzeneimidamide, propanimidamide, diaminopyridine, piperazinediamine, diaminopropane, ethylene glycol, triethylene glycol, succinic acid, sulfonic acid, levulinic acid, formic acid, phosphoric acid, 1,4-butanediol, and 2,3-butanediol, and combinations and mixtures of the foregoing. In a more preferred embodiment, the HBD comprises one or more of maleic acid, acrylic acid, methacrylic acid, acrylamide, 4-acryloylmorpholine, and mixtures thereof.

The HBD can be added to the mixture in any suitable concentration, including from about 0.1 wt. % to about 99 wt. % and all integers and decimals within this range.

### Hydrogen Bond Acceptor (HBA)

Preferred HBAs include, but are not limited to, choline chloride, vinyl acetate, urea, ethylammonium chloride, acetylcholine chloride, tetrabuytlphosphonium chloride, tetrabutylammonium chloride, cholinium bromide methacrylate, diallyldimethylammonium chloride (DMDAAC), and methyl methacrylate, alanine, betaine, glycine, guanidine hydrochloride, tetramethyl ammonium chloride, tetraethyl ammonium chloride, tetrapropyl ammonium chloride, methyl triethyl ammonium chloride, butyl trimethyl ammonium chloride, chlorocholine chloride, allyl trimethyl ammonium chloride, benzyl trimethyl ammonium chloride, benzyl triethyl ammonium chloride, and mixtures thereof.

The HBA can be added to the mixture in any suitable concentration, including from about 0.1 wt. % to about 99 wt. % and all integers and decimals within this range.

### Photoinitiators

A photoinitiator is included to facilitate photopolymerization. In a preferred embodiment, the photoinitiator is added to a mixture of at least one HBA and at least one HBD. Any suitable photoinitiator can be used including, Type I photoinitiators and Type II photoinitiators. Preferred type I photoinitiators include but are not limited to: diphenyl(2,4,6-Trimethylbenzoyl) phosphine oxide (TPO), Ethyl (2,4,6-trimethylbenzoyl)phenylphosphinate (TPO-L), 2-Methyl-4′-(methylthio)-2-morphinolinopropiophenone (MMMP), 2-Benzyl-2-(dimethylamino)-4′-morphinolinobutyrophenone (BDMB), Phenylbis(2,4,6-trimethylbenzoyl) phosphine oxide (BAPO/Irgacure 819), 2,2-Dimethoxy-2-phenylacetophenone (DMPA), 1-Hydroxycylohexylphenylketone (HCPK), 2,2-Diethoxy-1-phenylethanone (DEAP), and 2-Hydroxy-2-methylpropiophenone (PI1173). Examples of type II photoinitiators include but are not limited to: 3-Dione, 1,7,7-trimethyl-, (±-)-Bicyclo[2.2.1]heptane-2, ITX (2-Isopropylthioxanthone (CQ), and Benzil. Examples of co-initiators include but are not limited to: Ethyl 4-dimethylaminobenzoate. The term includes but is not limited to Common Visible Light Photoinitiators such as Bis (4-methoxybenzoyl) diethylgermanium (Ivocerin), Phenylbis(2,4,6-trimethylbenzoyl) phosphine oxide (BAPO), and Ethyl (2,4,6-trimethylbenzoyl)phenylphosphinate (TPO-L) and Common UV-light Photoinitiators such as Benzophenone, diphenyl(2,4,6-Trimethylbenzoyl) phosphine oxide (TPO), Phenylbis(2,4,6-trimethylbenzoyl) phosphine oxide (BAPO/Irgacure 819), 1-Hydroxycyclohexyl phenyl ketone (Irgacure 184), 2-benzyl-2-(dimethylamino)-4′-morpholinobutyrophenone (Irgacure 369), 2-Hydroxy-2-methylpropiophenone (Irgacure 1173), 2-Hydroxy-4′-(2-hydroxyethoxy)-2-methylpropiophenone (Irgacure 2959), 2,2′-Azobis[2-methyl-N-(2-hydroxyethyl) propionamide] (VA-086), 2,2-Dimethoxy-2-phenylacetophenone (DMPA/Irgacure 651), Diphenyl(2,4,6-trimethylbenzoyl) phosphine oxide (Darocur TPO/Lucirin TPO), Lithium phenyl (2,4,6-trimethylbenzoyl)phosphinate (LAP), and Ethyl (2,4,6-trimethylbenzoyl)phenylphosphinate (Lucirin TPO-L), and UV-light photoinitiators. Preferred UV-light photoinitiators include, but are not limited to, TPO, Irgacure 819, Irgacure, 184, Irgacure 369, ZnTP, aza-Br, CurCz, Eosin Y, Mes-Br, Irgacure 784, DAAQ, Safranine O, Rose begnal, ZnTPP, Ru(BPY)₃²⁺, KCD, TPA-DTP, H-Nu470, CQ, Ivocerin, NDP2, and combinations thereof. The photoinitiator more preferably comprises diphenyl(2,4,6-Trimethylbenzoyl) phosphine oxide (TPO), 1-hydroxycyclohexyl phenyl ketone (Irgacure 184), or a combination thereof. The structures of various photoinitiators are provided in the appendix in this application.

The photoinitiator can be added to the mixture in any suitable concentration to facilitate photopolymerization, including from about 0.1 wt. % to about 99 wt. % and all integers within this range.

In certain embodiments, it may be beneficial to include a co-solvent to aid the dissolution of the photoinitiator. Any suitable co-solvent can be employed provided it help with the dissolution and is compatible with the HBA and HBD. The amount of cosolvent will be dictated by the amount needed to dissolve the photoinitiator.

### Extraction Techniques and Device

The eutectic sorbents can be utilized in a number of extraction techniques and devices. For example, extraction techniques and devices which can include the eutectic sorbents disclosed herein include, but not limited to dispersive liquid-liquid extraction (DLLME), solid-phase microextraction (SPME), stir bar sorptive microextraction (SBSE), thin-film microextraction (TFME), vortex-assisted solid-phase microextraction (VA-DSPME), capsule-phase microextraction (CPME), and dispersive solid phase extraction (d-SPE).

An extraction device should include a projectile, an adhesive, and the eutectic sorbent. The printed eutectic sorbent can be in the form of a blade, a cylindrical fiber, or a number of other printed structures. Beneficially, the printed sorbent can have consistent thickness without being dipped. If printed as a blade, the blade preferably has a length of from about 0.1 millimeters to about 1 meter in length, more preferably 0.1 mm to about 0.5 meters, most preferably 0.1 mm to about 15 mm; a width of from about 0.5 millimeters to about 1 meter, more preferably 0.1 mm to about 0.5 meters, most preferably 0.1 mm to about 10 mm; and a height of from about 0.1 millimeters to about 1 meter, more preferably from about 0.1 mm to about 0.5 meters, most preferably from about 0.1 mm to about 100 mm; and any integer or decimal in the foregoing ranges. If printed as a cylindrical fiber, the fiber preferably has a diameter of from about 0.6 millimeters to about 1 meter in diameter and length of from about 0.1 millimeters to about 1 meter; and any integer or decimal in the foregoing ranges.

The eutectic sorbents can be used for any suitable extraction technique, which would typically include the steps of contacting the eutectic extraction sorbent with a sample, wherein the sample comprises an analyte; and wherein the analyte is a solid and is adsorbed, or a liquid and is absorbed. In a preferred embodiment, the method further comprising a step of desorbing the analyte from the eutectic extraction sorbent. In a preferred embodiment, the method of solid further comprises testing the analyte with an analytical instrument. In a preferred embodiment, the testing comprises quantifying the analyte and/or identifying qualitatively identifying the analyte.

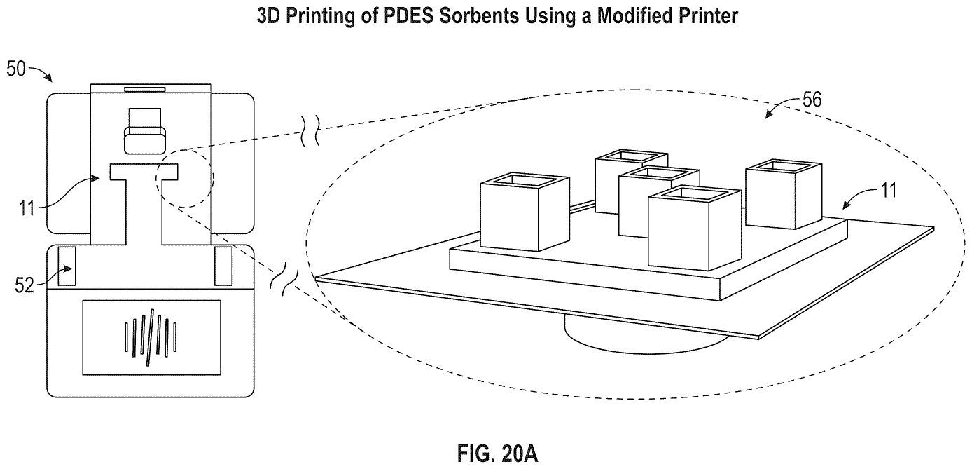

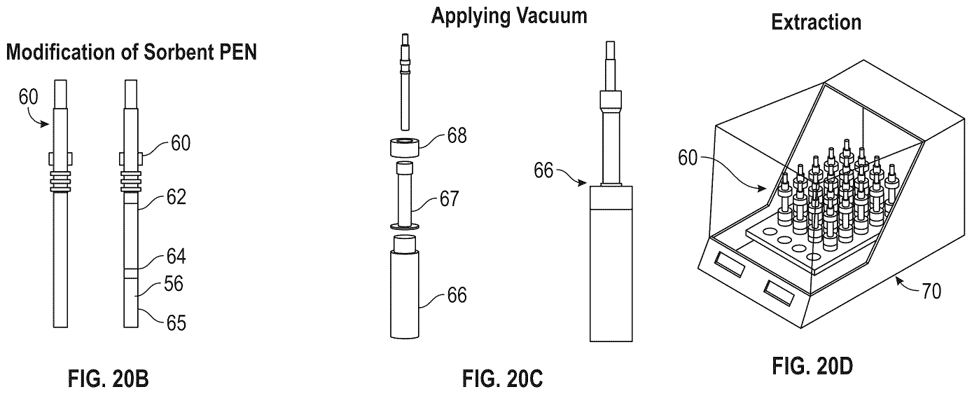

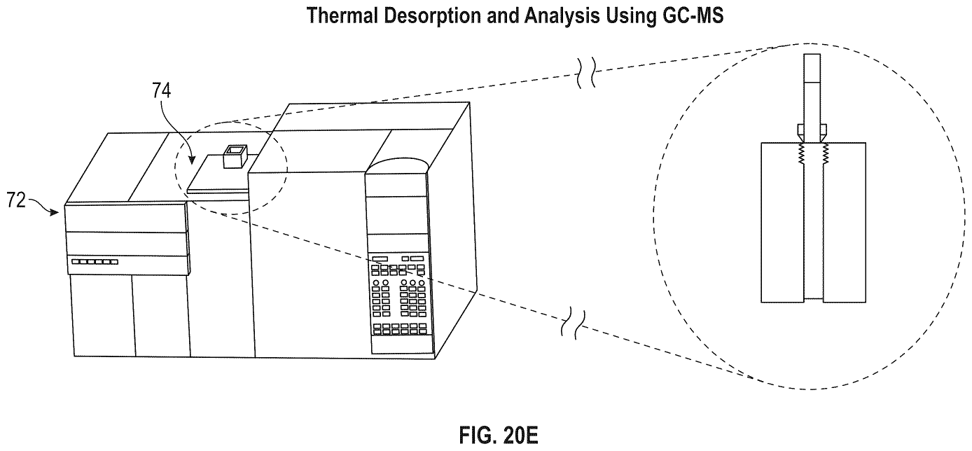

Vacuum-assisted sorbent extraction (VASE) can be used to preconcentrate an analyte using the 3D printed PDES sorbents. The VASE method is shown in FIG. 20. In a preferred embodiment, commercial sorbent pens are modified to hold the 3D printed PDES sorbents. In a preferred embodiment, the modified sorbent pens are placed in a sorbent pen extraction system (SPES) after vacuum sealing as illustrated in FIG. 20C.

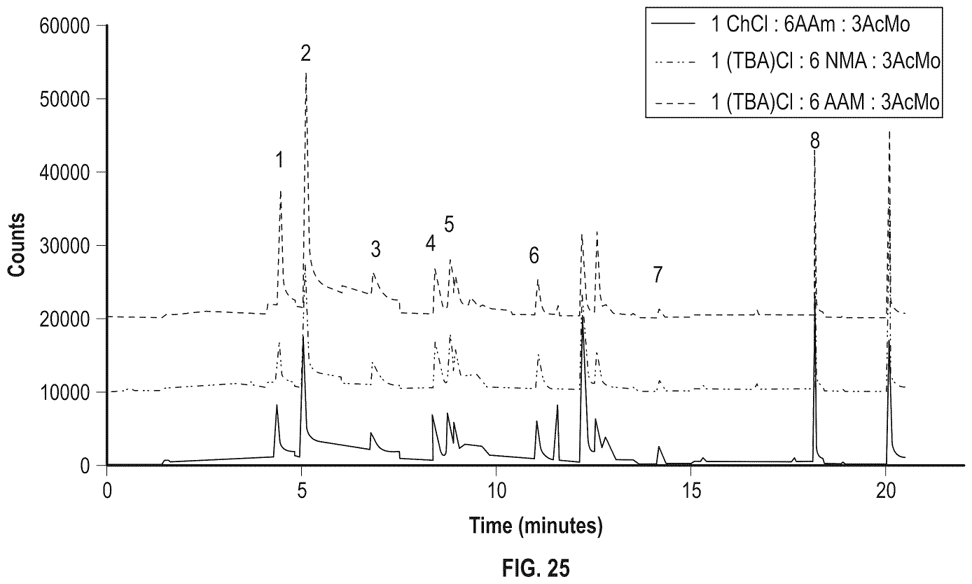

Suitable analytical instrument include but are not limited to a high performance liquid chromatography instrument (“HPLC”), an ultra-performance liquid chromatography instrument (“UPLC”), a next generation chromatograph (“NGC”), a mass spectrometer (“MS”), a gas chromatograph (“GC”), an instrument for isothermal amplification, a colorimeter, a fluorometer, a PCR machine, a photometer, a spectrometer, a spectrophotometer, a X-ray photoelectron spectrometer (“XPS”), or a combination thereof. If multiple instruments are included, they are preferably arranged sequentially and not in parallel; however, in some configurations parallel arrangement can be provided. In a preferred embodiment, gas chromatography followed by mass spectrometry (GC-MS) is used in combination with a desorption system. Representative results from GC-MS experiments are shown in FIG. 25.

### EXAMPLES

Embodiments of the disclosed methods are further defined in the following non-limiting Examples. These Examples, while indicating certain embodiments of the disclosed methods, are given by way of illustration only and should not be considered as limiting in any way. From the above discussion and these Examples, one skilled in the art can ascertain the essential characteristics of this disclosure, and without departing from the spirit and scope thereof, can make various changes and modifications of the embodiments of the disclosed methods to adapt it to various usages and conditions. Thus, various modifications of the embodiments of the disclosed methods, in addition to those shown and described herein, will be apparent to those skilled in the art from the foregoing description. Such modifications are also intended to fall within the scope of the appended claims.

TABLE 2
Compositions of deep eutectic solvents and prepolymer mixtures examined in this study.

| | Molar Ratio | | | | | | | | | TPO | 184 |
|---|---|---|---|---|---|---|---|---|---|---|---|
| Sample | ChCl | (TBA)Cl | (TBP)Cl | AAm | NMA | NIPAM | AA | AcMo | NVCL | (wt %) | (wt %) |
| 1 | 1 | 0 | 0 | 4 | 0 | 0 | 0 | 1 | 0 | 1 | 1 |
| 2 | 1 | 0 | 0 | 4 | 0 | 0 | 0 | 2 | 0 | 1 | 1 |
| 3 | 1 | 0 | 0 | 6 | 0 | 0 | 0 | 3 | 0 | 1 | 1 |
| 4 | 1 | 0 | 0 | 0 | 0 | 0 | 2.4 | 0 | 0 | 1 | 1 |
| 5 | 1 | 0 | 0 | 0 | 0 | 0 | 4.6 | 0 | 0 | 1 | 1 |
| 6 | 0 | 1 | 0 | 6 | 0 | 0 | 0 | 3 | 0 | 1 | 1 |
| 7 | 0 | 1 | 0 | 0 | 6 | 0 | 0 | 3 | 0 | 1 | 1 |
| 8 | 0 | 0 | 1 | 0 | 0 | 6 | 0 | 0 | 3 | 1 | 1 |

### Example 1

### Chemicals, Reagents and Apparatus

Deionized water (18.2 MΩ·cm), obtained from a Millipore Milli-Q water purification system, was used to prepare all standard solutions and in the post-processing of 3D printed sorbents. Two LCD Anycubic Photon Mono 4K and Anycubic Photon Mono 2 desktop 3D printers using a UV wavelength of 405 nm and an Anycubic Wash & Cure station were purchased from Anycubic Technology Co., Ltd. (Shenzhen, China). A Form 3+ SLA 3D printer and Form Cure were purchased from Formlabs (Somerville, MA, USA). Aluminum blocks (Grainger, Clifton, NJ, USA) were milled using a Super Mini Mill (HAAS, Oxnard, CA, USA). Glue sticks and a hot glue gun were sourced from Gorilla (Cincinnati, OH, USA). Corning™ 6-well cell culture plates were purchased from Corning Incorporated (New York, USA). Zinc plated machine screws ( 5/16″-18) and hex nuts were procured from Grip Fast (Wisconsin, USA). SYLGARD™ 184 silicone elastomer kit was obtained from Dow Chemical (Midland, MI, USA). N-(Hydroxymethyl) acrylamide (NMA) and N-isopropylacrylamide (NIPAM, stabilized with MEHQ) were purchased from Tokyo Chemical Industry (TCI, Tokyo, Japan). Choline chloride (ChCl) (98%), tetrabutylammonium chloride ((TBA)Cl, ≥97.0%), tetrabutylphosphonium chloride ((TBP)Cl, 96%), acrylamide (Aam) (99%), 4-acryloymorpholine (AcMo) (98%) and 1-Hydroxycyclohexyl phenyl ketone (Igacure 184) (99%) were purchased from MilliporeSigma (St. Louis, MO, USA). Diphenyl (2,4,6-Trimethylbenzoyl) phosphine oxide (TPO) (97%) was purchased from Aladin Industrial Co. Ltd. (Shanghai, China). Acrylic acid (AA) (≥99.5%) and N,N′-methylenebis(acrylamide) (97%) were purchased from Thermo Scientific Chemicals (Massachusetts, USA). An Isotemp vacuum drying oven model 280A from Fisher Scientific (Pittsburgh, USA) was applied in drying materials. A thermogravimetric analysis (TGA) and differential scanning calorimetry (DSC) instrument (Model Netzsch STA 440 F1 Jupiter, Netzsch Instruments North America, Burlington, MA, USA) was used for thermal stability studies.

The analytes β-pinene (analytical standard), trans-nerolidol (analytical standard), thymol (≥98.5%), menthol (racemic, ≥98.0%), geraniol (98%), and eugenol (99%) were purchased from Sigma-Aldrich (St. Louis, MO, USA). Linalool (97%) and δ-isoborneol (93%) were obtained from Acros Organics (Geel, Belgium). α-Terpinene (85%) was supplied by Aldrich (St. Louis, MO, USA). Terpinen-4-ol (≥95%) was purchased from TCI Chemicals (Tokyo, Japan). All analytes were prepared at a concentration of 500 mg/L in acetonitrile and stored at 4° C.

### Example 2

### LCD 3D Printer Modifications

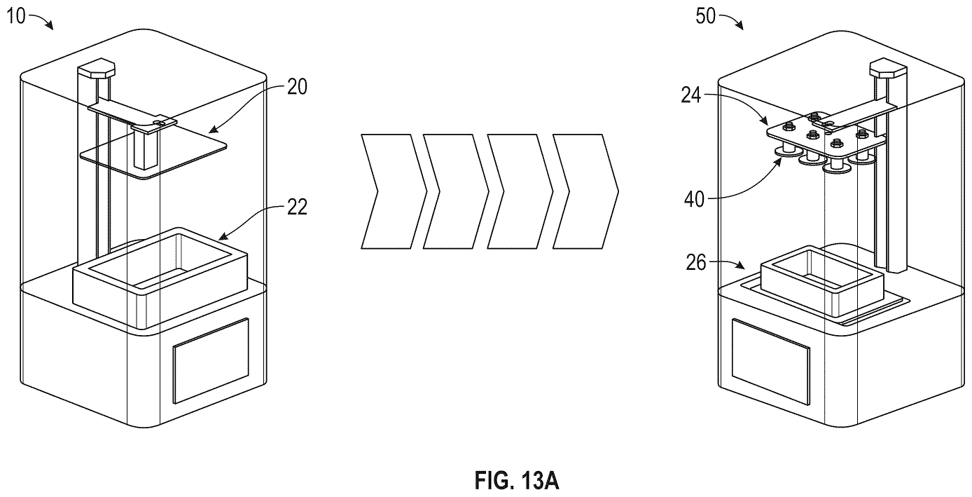

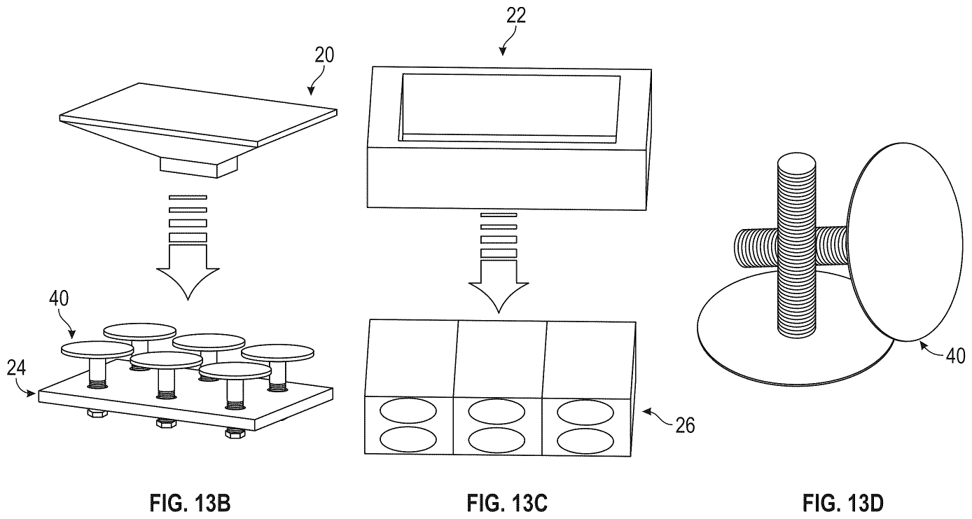

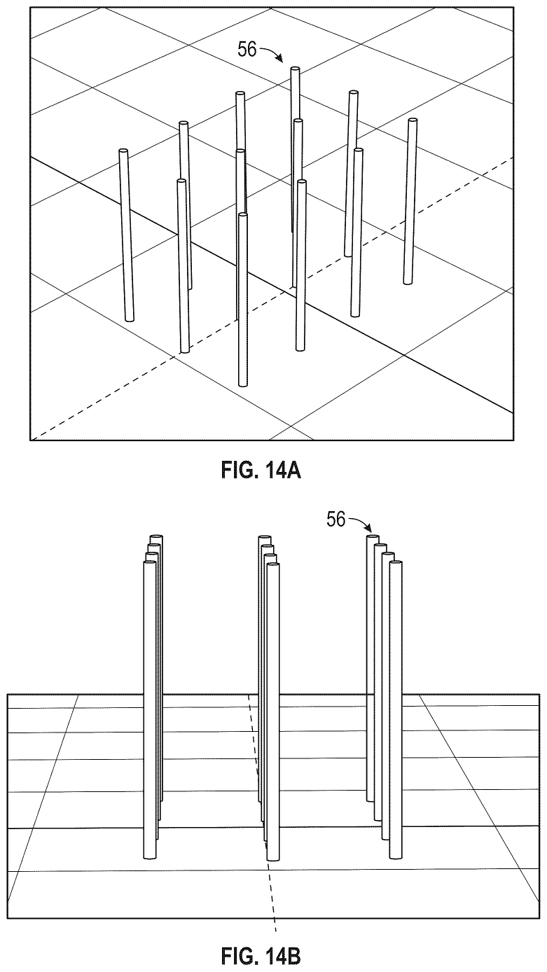

Miniaturization of the LCD 3D printer involved modifying the build plate holder, build plate and resin tank, as shown in FIGS. 13A-B. A customized build plates holder with 6 holes was designed and printed using black PLA filament by Ultimaker S5 3D printer with dimensions of 125 mm×85 mm×5 mm (L×W×H) as shown in FIGS. 13A-13C. The 6-hole build plates holder includes 6 circular holes with diameters of 8.5 mm. Screws and nuts were then applied to the printed build plate holder to serve as miniaturized build plates as shown in FIG. 13D. Cell plates (6-well) were used as miniaturized resin tanks and coated with PDMS.

### SLA 3D Printer Modifications

The modification of the SLA 3D printer involved three main components: the build plate, the resin tank, and sensors integrated into the printer, as shown in FIG. 17. A customized component for the Formlabs buildplate was designed, as illustrated in FIG. 17B and FIG. 18. It consists of a 120×120 mm square base plate with five raised platforms (26×26 mm cross-section, 25 mm height), including one central platform and four symmetrically positioned around it. The component was fabricated from an aluminum block using CNC machining. Aluminum was selected because it provides a chemically inert surface with reduced reactivity toward DESs, while also promoting the adhesion of PDES to the build plate; similar inert chemicals can be used in addition to or in replace of aluminum. The commercial Formlabs build plate incorporates an adaptor that facilitates the connection between the build plate and the printer. To integrate the customized build plate into the 3D printer, the adaptor from the commercial build plate was removed and attached to the new component. To modify the resin tank, walls were designed and fabricated using flexible resin with a Form 3+ SLA 3D printer, as shown in FIG. 17C. Each wall consisted of a square frame with external dimensions of 36×36 mm, an internal opening of 32×32 mm, and a height of 20 mm. Installation of these walls on the resin tank surface created confined regions that served as miniaturized resin tanks. The walls were aligned with the customized build plate and positioned on the resin tank surface so that each square base platform could easily fit into the corresponding compartment. To ensure proper sealing, hot glue was applied at the interfaces, providing both adhesion and insulation between the walls and the tank. The resulting confined cells enabled DES printing with reduced solution volumes, thereby improving efficiency. In addition, retaining the original resin tank lowered the surface area resulting in unwanted adhesion of prints to the bottom of the tank and reduced the risk of print failure.

### Example 3

### PDMS Coating Procedures for Miniaturized Resin Tank

To coat the resin tank, Corning™ cell culture plates were first cleaned with Kimwipes using water and methanol to ensure the removal of any dust particles. Then, the PDMS elastomer was poured into a small beaker at a volume ratio of 10 mL to 1 mL of the curing reagent, followed by thorough manual mixing. The mixture was poured into the wells until an approximate thickness of 1 mm was achieved. All coated resin tanks were left to cure for 24 hours at room temperature before use.

### Example 4

### Design and Characterization of 3D Printed Eutectic Sorbents for LCD and SLA Printers

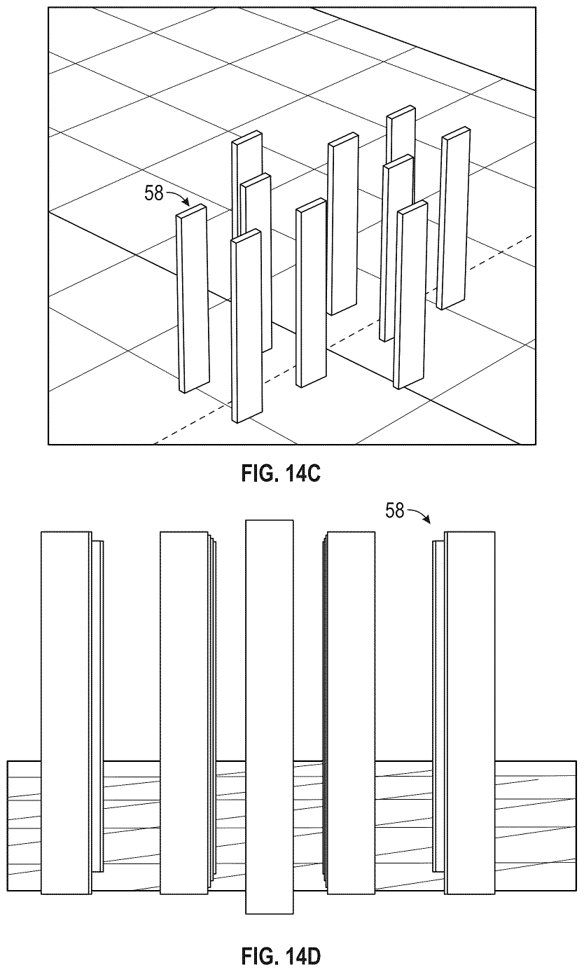

For the LCD 3D printer, the PDES sorbents were modeled using Inventor software. The eutectic sorbents were prepared in two forms blade-type sorbents with dimensions resembling metal blades used in Thin-film microextraction (TFME) and cylindrical sorbents used as solid-phase microextraction SPME fibers as shown in FIGS. 14A-D. The blade had dimensions of 15 mm (L)×2.5 mm (W)×0.5 mm (H), and the fiber had dimensions of 0.6 mm×12 mm (diameter×length). The design was saved and sent to the Photon Workshop slicer to set up printing parameters.

For the SLA 3D printer, fiber-type PDES sorbents with diameters of 0.3, 0.5, 0.7, and 0.9 mm (length: 12 mm) were modeled in Inventor software. The designs were exported into PreForm software for printing parameter setup, as illustrated in FIG. 19.

### Example 5

### Preparation of Deep Eutectic Sorbents

Prior to DES preparation, ChCl was dried in an oven under vacuum at 25° C. for 48 hours. (TBA)Cl and (TBP)Cl were stored in a desiccator. To prepare the DESs, ChCl and the monomers (AAm and AcMo or AA) were then mixed in 20 mL scintillation vials at different molar ratios, as provided in Table 2. To prepare the other DESs, (TBA)Cl and (TBP)Cl and the monomers (AAm, NMA, or NIPAM and AcMO or NVCL) were then mixed in 20 mL scintillation vials at different molar ratios, as provided in Table 2. The mixtures were heated to 60° C. and stirred under atmospheric pressure until a stable, homogeneous, colorless liquid was obtained. To prepare the prepolymer mixture, DES, TPO, and Irgacure 184 were mixed. The components of the eight prepolymer mixtures studied in this research are presented in Table 2. The mixture was subjected to a 1-minute vortex and 3-minute sonication at 20° C. to ensure all components were homogenously mixed and then covered with aluminum foil.

### Example 6

### LCD 3D Printer Printing Parameters and Post Curing Procedures

The printing parameters included a layer exposure time of 2 seconds for samples 1, 2, and 3, while an optimized exposure time of 10 seconds was used for samples 4 and 5. A bottom exposure time of 20 seconds and a z-axis lifting time of 0.5 seconds were applied for all samples. The layer thickness was set to 0.05 mm. Approximately 4 mL of the prepolymer mixture was required per well for successful printing. After printing, the samples were washed with ethanol to remove any residual liquid resin from their surfaces. Post-curing was carried out in an Anycubic Cure station using UV light at a wavelength of 405 nm at room temperature.

### SLA 3D Printer Printing Parameters and Post Curing Procedures

The SLA 3D printer printing parameters involved all samples printed at a fixed layer thickness of 0.050 mm. The laser exposure settings were as follows: perimeter fill exposure, 42.0 mJ/cm²; model fill exposure, 36.0 mJ/cm²; supports fill exposure, 168.0 mJ/cm²; and top surface exposure, 84.0 mJ/cm². The resin heater was enabled, with an operating temperature of 35° C. and a start temperature of 31° C. Wiping was disabled (wipe behavior set to 0), with a wipe speed of 50.0 mm/s and no initial wipes. Motion parameters included a roller squeeze speed of 10.0 mm/s and a post-laser cure wait time of 1.0 s. Following printing, the samples were washed with 2-propanol to remove residual liquid resin from their surfaces. Post-curing was carried out in a Form Cure station under UV light at 50° C. for 40 minutes.

### Example 7

### Investigating the Printability of DESs Prepolymer Mixtures for Fabricating PDES Sorbents Using SLA and LCD 3D Printers

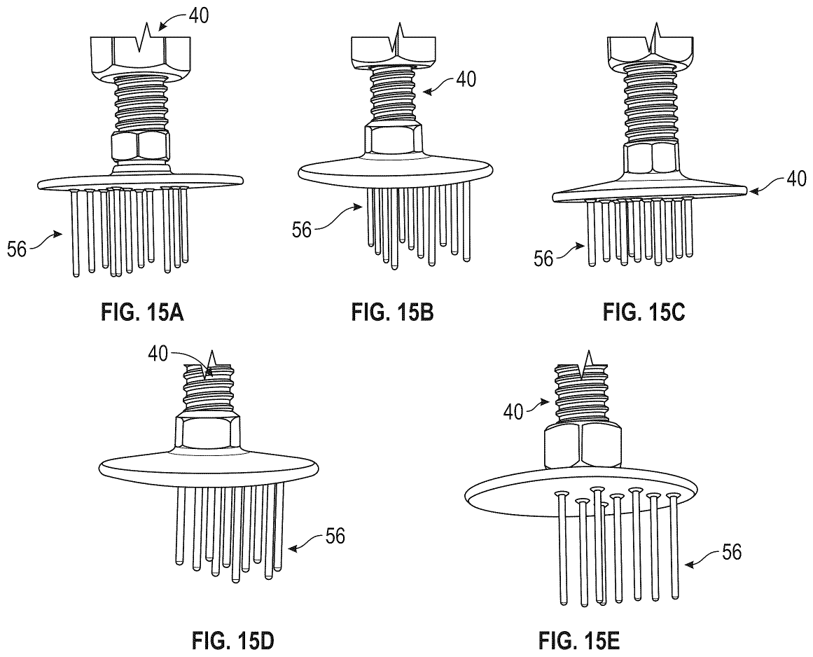

After the preparation of DESs, the prepolymer mixtures were made by mixing the DESs with the photoinitiators TPO and Irgacure 184. To achieve a homogeneous and printable mixture, various mixing methods were tested using samples 1, 2, and 3. The most efficient method, which produced a clear and uniform mixture, was selected. The process involved vortexing the DES, TPO, and Irgacure 184 mixtures for 1 minute, followed by ultrasonic treatment in a bath for 3 minutes, and then agitating them on a shaker at 1500 RPM for 15 minutes. A clear liquid suitable for printing was obtained for both sample 1 and sample 3, while sample 2 produced a turbid solution. Despite this, all three samples were successfully used for 3D printing fibers and blades. 3D-printed PDES fibers are shown in FIGS. 15A-B.

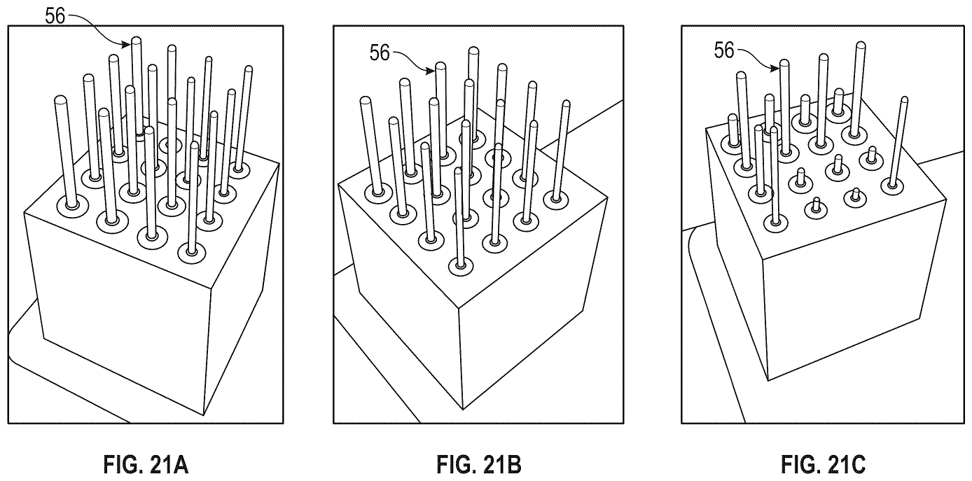

To demonstrate the versatility of the printer in processing different DESs, a range of HBAs and HBDs were selected to prepare eight DESs, as summarized in Table 2. All eight DESs were successfully printed using the LCD 3D printer. FIG. 15 shows photographs of the 3D printed fibers obtained from samples 1-5. In addition, samples 3, 6, 7, and 8 were printed using the SLA 3D printer as shown in FIG. 21.

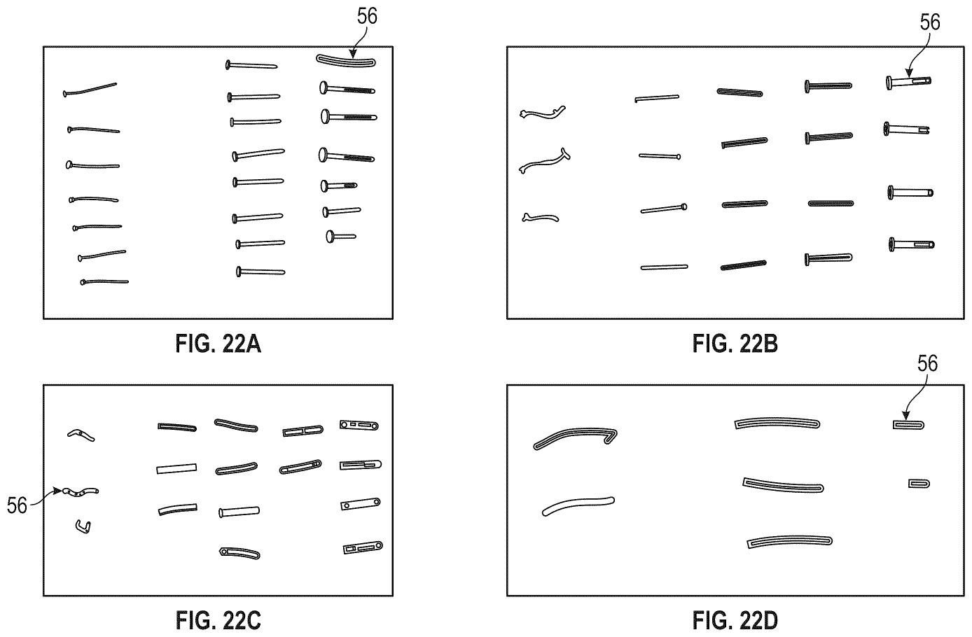

To compare printing resolution and evaluate which printer performs more successfully in fabricating PDESs, samples 3, 6, 7, and 8 were printed using both LCD and SLA printers. As shown in FIG. 22, the SLA printer provided higher resolution and achieved a greater printing success rate compared to the LCD printer for the tested DESs.

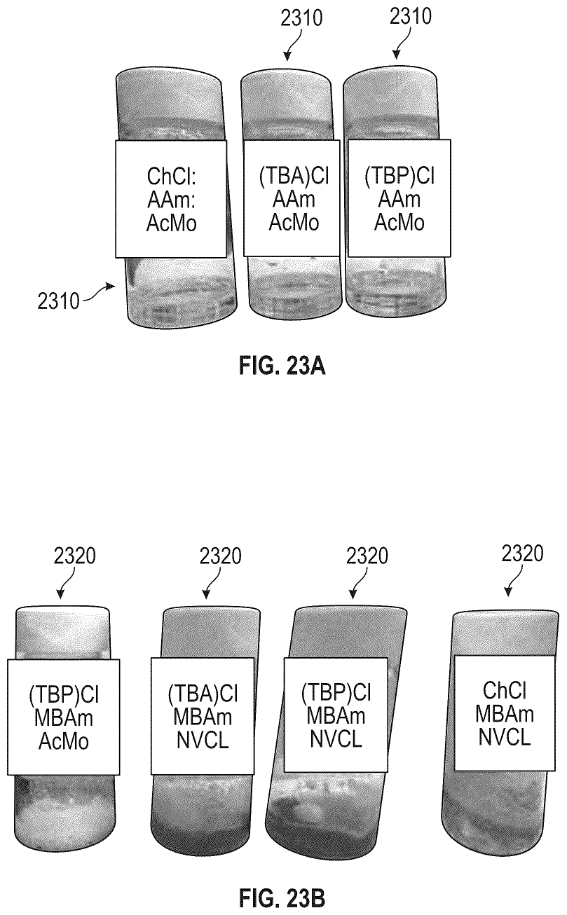

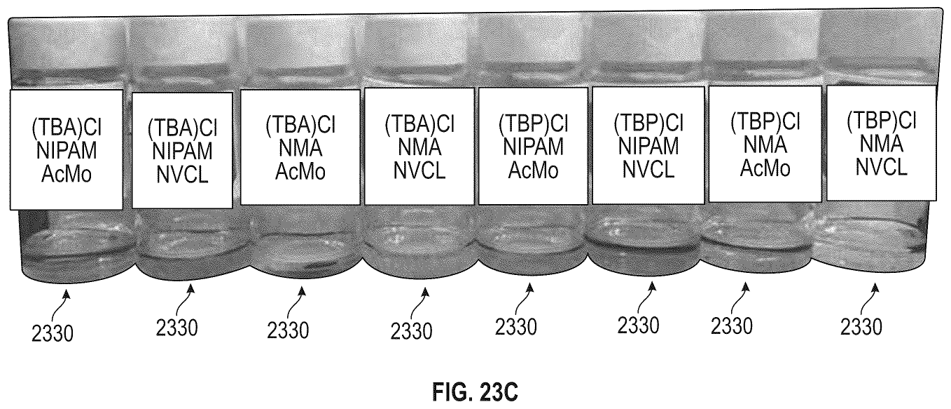

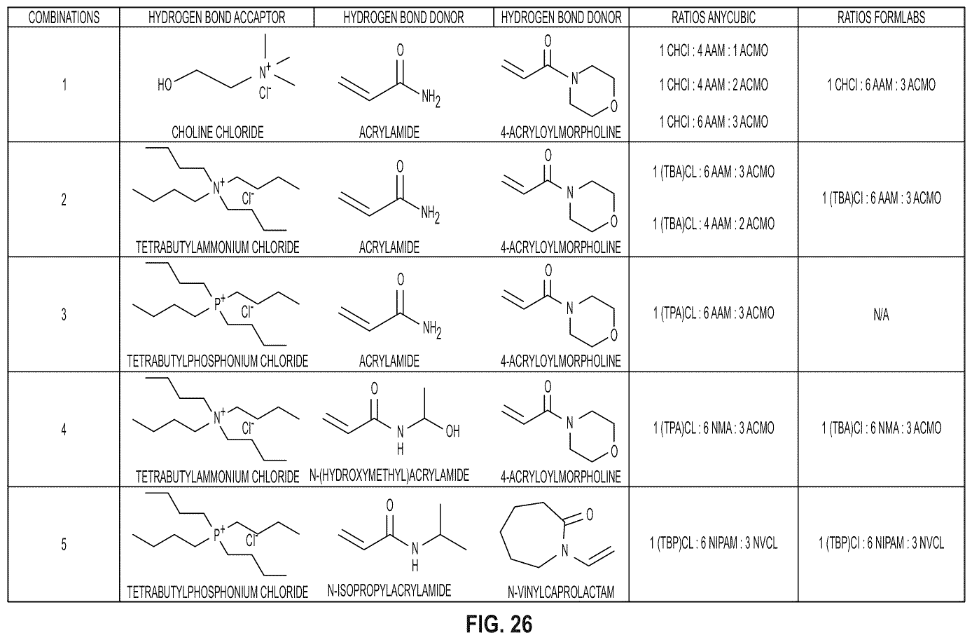

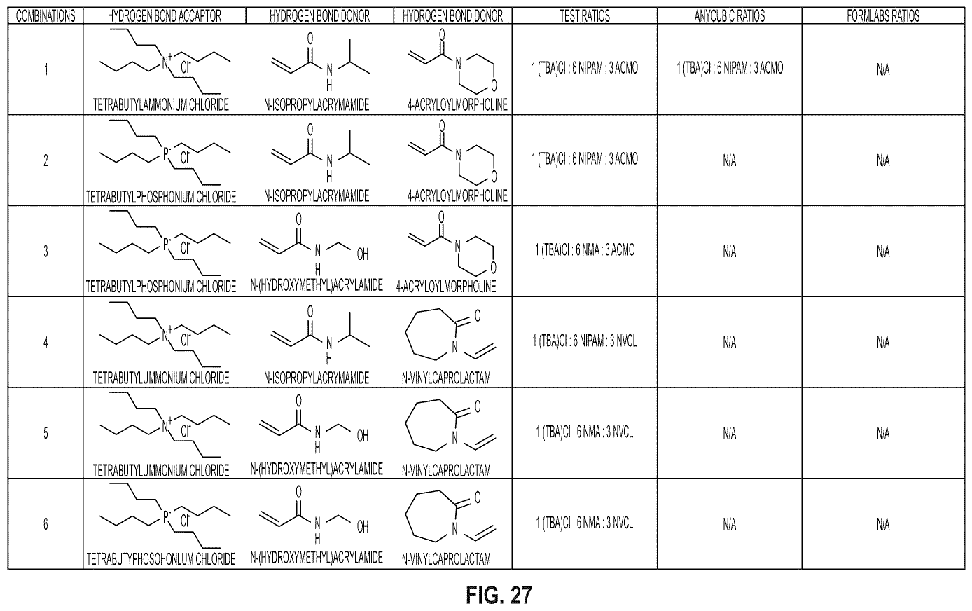

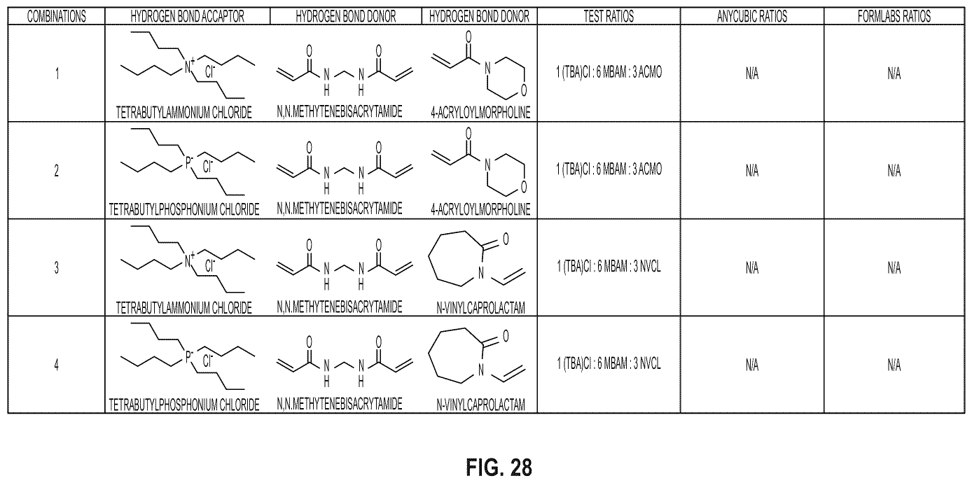

Although several DESs were successfully printed, as presented in Table 2 and FIG. 26, some DESs were only preliminarily tested and were not printable using either the LCD or SLA printers, as shown in FIG. 27. Specifically, FIG. 28 reports DESs prepared with MBAm as the HBD. MBAm was investigated as a potential polymerizable HBD but proved unsuccessful due to its divinyl structure, which led to immediate cross-linking and the formation of brittle polymers, as illustrated in FIG. 23B.

### Example 8

### Printing Reproducibility.

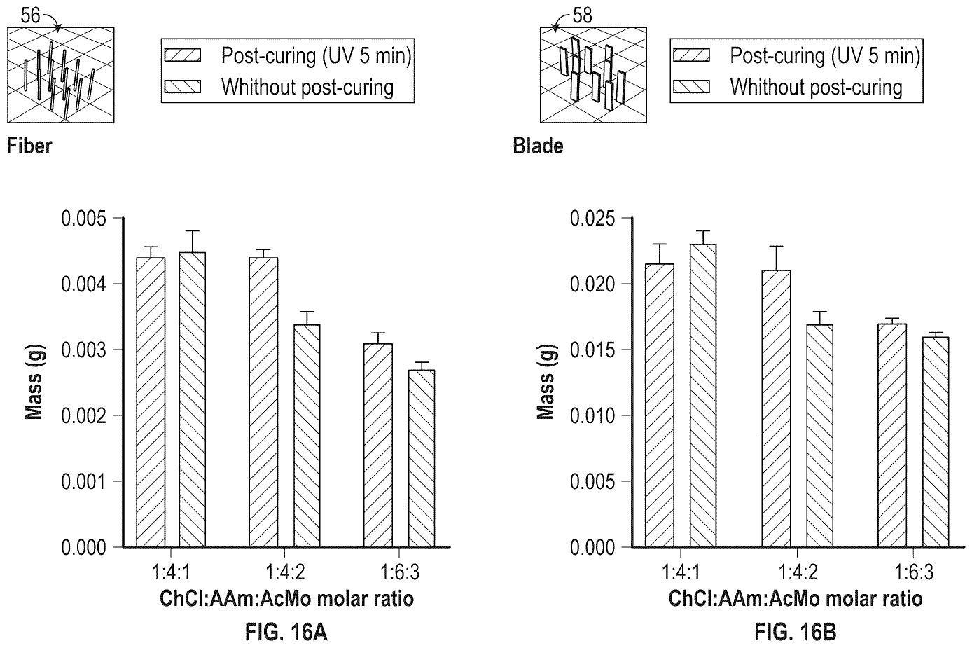

One of the key advantages of 3D printers is their ability to print with high repeatability. To evaluate the repeatability of the printer in fabricating PDES fibers, different PDES fibers from Samples 1, 2, and 3 were printed using the optimized mixing procedure. The weights of the printed fibers and blades were compared. Additionally, the fiber and blade weights were measured before and after UV curing, and the results are presented in FIG. 16 respectively. As shown in FIG. 16, the standard deviation among the different fibers and blades was low, indicating high repeatability.

### Versatility of the Modified 3D Printer in Printing Various DESs.

To demonstrate the versatility of the printer in printing various DESs, different DESs were prepared and tested using a range of HBDs. AA was employed as a polymerizable HBD, and AA based-DESs (ChCl:AA) were prepared in the 1:2.4 and 1:4.2 molar ratio, as shown in Table 2. FIGS. 15D-E show the 3D printed PDESs fibers, printed using AA based-DESs.

### Example 9

### Assembly of the Extraction Device Containing the 3D Printed PDES Extraction Sorbent

To enable evaluation of extraction and thermal desorption of the 3D printed PDES sorbents, vacuum-assisted sorbent extraction (VASE) technique was employed using modified sorbent pens, as shown in FIG. 20. First, a commercial sorbent pen from Entech Instruments (Simi Valley, CA, USA) was disassembled and all internal components were removed. A mesh was placed at the bottom of the pen housing, onto which a 3D printed PDES sorbent was positioned, followed by insertion of a cork piece obtained from the original sorbent pen, as shown in FIG. 20B. The device was reassembled and conditioned using a sorbent pen thermal conditioner (3801 SPTC, Entech Instruments, Simi Valley, CA, USA) under the following settings: pre-purge duration, 10 min; number of cycles, 2; conditioning duration, 30 min; and temperature, 75° C.

### Example 10

### Vacuum-Assisted Sorbent Extraction and Desorption Procedures

The extraction procedure was conducted using the VASE system, including vial caps, vials, lid, as shown in FIG. 20B, sorbent pen extraction system (SPES) unit, as illustrated in FIG. 20D, as well as modified sorbent pens.

Extractions were performed in 40 mL amber glass vials containing 10 mL of water spiked with analytes at a concentration of 300 μg/L of the standard solution. Modified sorbent pens were connected to the vials, and air was evacuated to create a vacuum by directly connecting the SP Micro QT™ to a vacuum pump until the pressure was reduced below −25 inHg, as shown in FIG. 20C. The vacuum of the vial/pen assembly was maintained at −25 inHg throughout the entire extraction period.

Following vacuum sealing, the sorbent pens and vials were placed on a 5600 SPES for 180 min at 150 rpm and 50° C. To prevent water vapor accumulation and condensation inside the extraction vials and sorbent pens, a water management step was applied after each extraction. In this step, the extraction vial and the sorbent pen were transferred into a precooled block set at −20±2° C. for 10 min.

### Example 11

### Thermal Desorption and GC Analysis

Desorption and analysis were carried out using a 7890B gas chromatograph (GC) coupled with a 5977A single-quadrupole mass spectrometer (MS) (Agilent Technologies, Santa Clara, CA, USA) in combination with a 5800 Sorbent Pen Desorption Unit (SPDU) (Entech Instruments), as illustrated in FIG. 20E. Ultrapure helium was employed as carrier gas at a flow rate of 1 mL min⁻¹ and a wide-bore Silonite™-coated pre-column (0.6 m×1 mm) from Entech Instruments and A Rtx-5 ms capillary column (30 m×0.25 mm I.D.×25 μm film thickness) from Restek (Bellefonte, PA, USA) was used for the separation of analytes. The SPDU was operated under programmed conditions. The desorber was kept idle at 55° C., with no preheating applied. Desorption was performed at 80° C. for 3.0 min, after which a bake-out step was carried out at 70° C. for 6.0 min. A post-bake stage followed, lasting 11.5 min at 70° C. The separation was carried out using the following oven temperature program: the initial temperature was set at 80° C. and maintained for 1.0 min, followed by an increase at a rate of 4° C. min⁻¹ to 130° C. Then, the temperature was increased at a rate of 10° C. min⁻¹ to 200° C., with a total run time of 20.5 min. The GC-MS transfer line was maintained at 280° C. The mass spectrometer was operated in electron ionization (EI) mode 70 eV. The ion source and quadrupole temperatures were fixed at 230° C. and 150° C., respectively. Full scan data were acquired across a mass range of m/z 50-550, and selected ion monitoring (SIM) was applied for targeted analysis.

The ions monitored for each analyte (quantifier ion in bold) were as follows: β-pinene 69, 77, 93 m/z; Terpinene 93, 121, 136 m/z; Linalool 55, 71, 93 m/z; Isoborneol 95, 110, 121 m/z; Menthol 71, 81, 95 m/z; 4-Terpineol 71, 93, 111 m/z; Geraniol 69, 93, 123 m/z; Thymol 91, 135, 150 m/z; Eugenol 103, 149, 164 m/z; Nerolidol 69, 93, 107 m/z;

### Example 12

### Characterization of Thermal Stability of 3D Printed PDES Fibers

To evaluate the thermal stability of the 3D-printed PDES sorbents, thermogravimetric analyses (TGA) were performed using a Netzsch STA449 F1/DSC instrument. Samples (˜5 mg) were placed in crucibles and heated from 40 to 250° C. at a rate of 5° C./min under a nitrogen flow of 20 mL/min. In this study, the TGA profiles of ChCl-based PDES and TBACl-based PDES were obtained, as shown in FIG. 24.

### Example 13

### Application of PDES as an Extraction Sorbent in a Modified Sorbent Pen

To evaluate the performance and compatibility of PDES fibers as extraction sorbents following GC desorption, extractions based on the VASE technique were performed using modified sorbent pens containing PDES. The modified pens were applied to the extraction of ten terpenes, namely: β-pinene, terpinene, linalool, isoborneol, menthol, 4-terpineol, geraniol, thymol, eugenol, and nerolidol.

Three types of modified pens were prepared using different 3D printed PDES fibers: (i) 1 ChCl: 6 AAm: 3 AcMo (red), (ii) 1 (TBA)Cl: 6 NMA: 3 AcMo, and (iii) 1 (TBA)Cl: 6 AAm: 3 AcMo. Extractions were subsequently carried out with these modified pens. The chromatograms of selected ion scans obtained from these extractions are presented in FIG. 25. As shown, the modified pens successfully extracted eight different terpene analytes.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

List of Reference Characters

| | |
|---|---|
| 10 | 3D printer |
| 11 | Custom build plate |
| 12 | Build plate |
| 14 | Material tank |
| 16 | 3D printing material |
| 18 | Light source |
| 20 | Commercial build plate |
| 22 | Commercial material tank |
| 24 | Six-hole build plate |
| 26 | Six-well cell plate |
| 28 | Twenty-four-hole build plate |
| 30 | Twenty-four-hole cell plate |
| 32 | 5/16″-18 screw |
| 34 | Hex nut |
| 36 | Magnet |
| 38 | Washer |
| 40 | Flat head screw |
| 50 | Modified 3D printer |
| 52 | Custom material tank |
| 54 | Build plate platform |
| 56 | 3D printed fiber |
| 58 | 3D printed blade |
| 60 | Sorbent pen |
| 62 | Sorbent pen housing |
| 64 | Cork |
| 65 | Mesh |
| 66 | Vial |
| 67 | Vial lid |
| 68 | Vial cap |
| 70 | Sorbent pen extraction system |
| 72 | Gas chromatography-mass spectrometry system |
| 74 | Thermal desorption unit |
| 2310 | Printed prepolymer mixture |
| 2320 | Cross-linked prepolymer mixture |
| 2330 | Tested prepolymer mixture |

From the foregoing, it can be seen that the present disclosure accomplishes at least all of the stated objectives.

The inventions being thus described, it will be obvious that the same may be varied in many ways. Such variations are not to be regarded as a departure from the spirit and scope of the inventions and all such modifications are intended to be included within the scope of the following claims.

The above specification provides a description of a system, a eutectic extraction sorbents, and a method, all of which includes various eutectic extraction sorbent printed by a 3D printer. Since many embodiments can be made without departing from the spirit and scope of the present disclosure, the invention resides in the claims.

The scope of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A system for 3D printing eutectic extraction sorbents comprising:
a photocuring 3D printer utilizing a build plate having a plurality of holes and a resin tank formed of a plurality of individual wells with a mixture of a hydrogen bond donor, a hydrogen bond acceptor, and a photoinitiator, the mixture placed in the plurality of wells to form a plurality of 3D printed eutectic extraction sorbents on the build plate;
a fabrication device that prepares the 3D printed eutectic extraction sorbents for extraction;
at least one container for conditioning, extraction, and desorption of the 3D printed eutectic extraction sorbents.

2. The system of claim 1, wherein the build plate having a plurality of holes is 3D printed and the resin tank is formed of a plurality of individual wells.

3. The system of claim 2, wherein the resin tank formed of a plurality of individual wells are each coated with an elastomer.

4. The system of claim 1, wherein the extraction device includes a projectile and an adhesive.

5. The system of claim 1, wherein the 3D printed eutectic extraction sorbent is in the form of either a blade sorbent or fiber sorbent.

6. A eutectic extraction sorbent comprising:
a eutectic material comprised of a hydrogen bond donor and a hydrogen bond acceptor,
wherein the eutectic extraction sorbent is in the form of a blade or a fiber; wherein the hydrogen bond donor comprises N-(hydroxymethyl) acrylamide, N-isopropylacrylamide, N-vinylcaprolactam, maleic acid, acrylic acid, methacrylic acid, acrylamide, itaconic acid, 4-acryloylmorpholine, malonic acid, N,N′-methylenebis(acrylamide), hydroxyethyl methacrylate, citric acid, amidoxime, tannic acid, oxalic acid, benzeneimidamide, trifluorobenzeneimidamide, propanimidamide, diaminopyridine, piperazinediamine, diaminopropane, ethylene glycol, triethylene glycol, succinic acid, sulfonic acid, levulinic acid, formic acid, phosphoric acid, 1,4-butanediol, and 2,3-butanediol, or a combination or mixture of the foregoing; and
wherein the hydrogen bond acceptor comprises choline chloride, vinyl acetate, urea, ethylammonium chloride, acetylcholine chloride, tetrabutylphosphonium chloride, tetrabutylammonium chloride, cholinium bromide methacrylate, diallyldimethylammonium chloride (DMDAAC), and methyl methacrylate, alanine, betaine, glycine, guanidine hydrochloride, tetramethyl ammonium chloride, tetraethyl ammonium chloride, tetrapropyl ammonium chloride, methyl triethyl ammonium chloride, butyl trimethyl ammonium chloride, chlorocholine chloride, allyl trimethyl ammonium chloride, benzyl trimethyl ammonium chloride, benzyl triethyl ammonium chloride, or a mixture thereof.

7. The eutectic extraction sorbent of claim 6, wherein the eutectic extraction sorbent is prepared from a mixture of a hydrogen bond donor and a hydrogen bond acceptor, wherein the hydrogen bond donor comprises acrylamide, 4-acryloymorpholine, acrylic acid, and/or mixtures thereof, and the hydrogen bond acceptor comprises choline chloride.

8. The eutectic extraction sorbent of claim 6, wherein the sorbent is in the form of a blade having a length of from about 0.1 mm to about 1 m, a width of from about 0.5 mm to about 1 m, and a height of from about 0.1 mm to about 1 m in height.

9. The eutectic extraction sorbent of claim 6, wherein the sorbent is in the form of a fiber having a length of from about 0.1 mm to about 1 m, and a diameter from about 0.6 mm to about 1 m.

10. The eutectic extraction sorbent of claim 7, wherein the sorbent is prepared with a photoinitiator, and wherein the photoinitiator comprises a Type I photoinitiator and/or Type II photoinitiator.

11. The eutectic extraction sorbent of claim 7, wherein the HBA and HBD are in a ratio of from about 1:1 to about 1:8.

12. A method of manufacturing eutectic extraction sorbents comprising:
placing a hydrogen bond donor and a hydrogen bond acceptor with a photoinitiator into a customized resin tank formed of a plurality of individual wells;
wherein the hydrogen bond donor comprises N-(hydroxymethyl) acrylamide, N-isopropylacrylamide, N-vinylcaprolactam, maleic acid, acrylic acid, methacrylic acid, acrylamide, itaconic acid, 4-acryloylmorpholine, malonic acid, N,N′-methylenebis(acrylamide), hydroxyethyl methacrylate, citric acid, amidoxime, tannic acid, oxalic acid, benzeneimidamide, trifluorobenzeneimidamide, propanimidamide, diaminopyridine, piperazinediamine, diaminopropane, ethylene glycol, triethylene glycol, succinic acid, sulfonic acid, levulinic acid, formic acid, phosphoric acid, 1,4-butanediol, and 2,3-butanediol, or a combination or mixture of the foregoing; and
wherein the hydrogen bond acceptor comprises choline chloride, vinyl acetate, urea, ethylammonium chloride, acetylcholine chloride, tetrabutylphosphonium chloride, tetrabutylammonium chloride, cholinium bromide methacrylate, diallyldimethylammonium chloride (DMDAAC), and methyl methacrylate, alanine, betaine, glycine, guanidine hydrochloride, tetramethyl ammonium chloride, tetraethyl ammonium chloride, tetrapropyl ammonium chloride, methyl triethyl ammonium chloride, butyl trimethyl ammonium chloride, chlorocholine chloride, allyl trimethyl ammonium chloride, benzyl trimethyl ammonium chloride, benzyl triethyl ammonium chloride, or a mixture thereof;
utilizing a photocuring 3D printer having a build plate with a plurality of holes and the customized resin tank formed of a plurality of individual wells; and
printing the eutectic extraction sorbent.

13. The method of manufacturing eutectic extraction sorbents of claim 12, wherein the hydrogen bond donor comprises acrylamide, 4-acryloymorpholine, acrylic acid, and/or mixtures thereof and the hydrogen bond acceptor comprises choline chloride.

14. The method of manufacturing eutectic extraction sorbents of claim 12, further comprising the step of removing any uncured residual resin after the printing.

15. The method of manufacturing eutectic extraction sorbents of claim 14, further comprising the step of post-curing by applying UV light to the eutectic extraction sorbents after removing any uncured residual resin; optionally further comprising the step of washing with a solvent, wherein the solvent is optionally water.

16. A method of analyte extraction comprising:
contacting the eutectic extraction sorbent of claim 1 with a sample, wherein the sample comprises an analyte; and wherein the analyte is a solid and is adsorbed, or a liquid and is absorbed.

17. The method of analyte extraction of claim 16, further comprising a step of desorbing the analyte from the eutectic extraction sorbent.

18. The method of analyte extraction of claim 17, further comprising testing the analyte with an analytical instrument; wherein the analytical instrument comprises a high performance liquid chromatography instrument (“HPLC”), an ultra-performance liquid chromatography instrument (“UPLC”), a next generation chromatograph (“NGC”), a mass spectrometer (“MS”), a gas chromatograph (“GC”), an instrument for isothermal amplification, a colorimeter, a fluorometer, a PCR machine, a photometer, a spectrometer, a spectrophotometer, a X-ray photoelectron spectrometer (“XPS”), or a combination thereof.

19. The method of analyte extraction of claim 18, wherein the testing comprises quantifying the analyte.

20. The method of analyte extraction of claim 16, wherein the contacting is performed by dispersive liquid-liquid extraction (DLLME), solid-phase microextraction (SPME), stir bar sorptive microextraction (SBSE), thin-film microextraction (TFME), vortex-assisted solid-phase microextraction (VA-DSPME), capsule-phase microextraction (CPME), and/or dispersive solid phase extraction (d-SPE).
